(19) United States
(12) Patent Application Publication
(10) Pub. No.: US 2025/0001345 A1
(43) Pub. Date: Jan. 2, 2025

(54) SAFETY FILTER ELEMENT

(71) Applicant: Donaldson Company, Inc., Bloomington, MN (US)

(72) Inventors: Bart CATOOR, Kessel-Lo (BE); Mathijs VERSTRAETE, Tienen (BE); Kristof DECOSTER, Vilvoorde (BE); Gunther VAN DE POEL, Waanrode (BE)

(21) Appl. No.: 18/692,296

(22) PCT Filed: Sep. 16, 2022
(86) PCT No.: PCT/US2022/076590

§ 371 Date: Mar. 14, 2024

Related U.S. Application Data
(60) Provisional application No. 63/245,612, filed on Sep. 17, 2021.

(51) Int. Cl. B01D 46/64; B01D 46/00; B01D 46/52

(52) U.S. Cl. CPC B01D 46/64; B01D 46/0005; B01D 46/525; B01D 2271/02

(57) ABSTRACT

The present disclosure relates to a safety filter element for backing up a failure of a main filter element comprising a primary filter medium pack. The safety filter element comprises a secondary filter medium pack and a shell wherein a first portion of an inner side of a circumferential wall of the shell is surrounding a circumferential side of the secondary filter medium pack, and wherein a second portion of the inner side of the circumferential wall of the shell is radially delimiting a cavity located between a first opening of the shell and a fluid inlet side of the secondary filter medium pack. The cavity allows for receiving or at least partly receiving the primary filter medium pack of the main filter element. The safety filter element comprises a first seal member that comprises a first circumferential sealing portion for sealing to the shell and a second circumferential sealing portion for sealing to the main filter element. The second circumferential sealing portion has a contour shape of single-fold rotational symmetry.

### CROSS-REFERENCE TO RELATED APPLICATION

This application is being filed on Sep. 16, 2022, claims the benefit of and priority to U.S. Provisional Application Ser. No. 63/245,612, filed Sep. 17, 2021, the disclosure of which is hereby incorporated by reference in its entirety.

### FIELD OF THE DISCLOSURE

The present disclosure generally relates to filter elements and filter assemblies. More precisely, the disclosure relates to safety filter elements for backing up a failure of a main filter element comprising a primary filter medium pack.

### BACKGROUND

Filter elements for filtering a fluid, also referred to as filter cartridges, are used for a wide variety of filtering applications. The fluid can be a liquid or a gas including, for example, air.

The filter element is generally an element that is to be removed and replaced from a housing of the filter system at regular time intervals or when the filtering performance has dropped below a critical threshold level.

The filter element includes a filter medium pack including filter media for removing contaminant materials when the fluid flows through the filter media. Commonly used and commercially available filter media are for example pleated media or fluted media. The fluted media are also referred to as Z-filter media.

More advanced filter assemblies, for example air filter assemblies for vehicles, comprise two filter elements, a primary filter element, also named main filter element, and a secondary filter element, also named safety filter element.

The safety filter element backs up the main filter element and thereby protects for example the engine of a vehicle while the primary filter is out of the housing during service.

The safety filter element also protects the engine against hidden damage to the primary filter element, e.g., damage from cleaning, or against a malfunction of the primary filter element, e.g., due to mis-installation or due to installation of the wrong size primary filter element.

Generally, compared to a primary filter element, the safety filter element is more open for lower restriction and is less efficient. Therefore, the safety filter element generally does not increase the overall operating efficiency of the filter system.

The lifetime of the safety seal element is generally also much longer than the lifetime of the main filter element, for example two to four times longer, and hence the replacements intervals for the primary and the secondary filter elements are different.

Typically, as disclosed for example in US2018/0369735A1, the safety filter element and main filter element each comprise a seal member for sealing against an inner wall of a housing of a filter system. Those seal members are replaced according to the maintenance procedures which take into account the specifications of the seal members with respect to lifetime. Generally, the seal member of the main filter element is replaced as part of the replacement of the entire filter element.

On one hand, there is a need in industry to maximize the use of certain filter components and only replace filter components when effectively needed. On the other hand, there is also a need to guarantee that the various components of filter assemblies are correctly installed and secured within the housing of the filter system. There is a further need to provide filter elements and components that can be assembled in a straightforward and fast way, thereby facilitating the maintenance operations.

Hence, there is room for improving safety filter elements and filter assemblies comprising a safety filter element and a main filter element that at the same time facilitate maintenance procedures and guarantee a secure and correct installation.

### SUMMARY

It is an object of the present disclosure to provide a safety filter element for filtering fluids that facilitates and secures maintenance operations.

The present disclosure is defined in the appended independent claims. The dependent claims define advantageous embodiments.

According to a first aspect of the present disclosure, a safety filter element for backing up a failure of a main filter element comprising a primary filter medium pack is provided. In embodiments, the main filter element is, for example, a main filter element for air cleaning.

The safety filter element comprises a secondary filter medium pack having a circumferential side that is extending in a longitudinal direction from a fluid inlet side to a fluid outlet side, and a shell comprising a circumferential wall that is extending in the longitudinal direction from a first opening at a first end of the shell to a second opening at a second end of the shell. A first portion of an inner side of the circumferential wall of the shell is surrounding the circumferential side of the secondary filter medium pack, and a second portion of the inner side of the circumferential wall of the shell is radially delimiting a cavity located between the first opening of the shell and the fluid inlet side of the secondary filter medium pack for receiving, or at least partly receiving, the primary filter medium pack of the main filter element.

The safety filter element further comprises a first seal member comprising a first circumferential sealing portion for sealing to the shell and a second circumferential sealing portion for sealing to the main filter element when the primary filter medium pack of the main filter element is received in the cavity, and wherein the second circumferential sealing portion of the first seal member has a contour shape of single-fold rotational symmetry.

By providing a safety filter element having a shell that forms a cavity for receiving the main filter medium pack, a service tool is provided that forms a valuable interface between the housing of a filter system and the main filter element. Indeed, as the frequency for replacing the secondary filter medium pack is much lower than the frequency for replacing the primary filter medium pack, during replacement of the main filter element, the safety filter element can remain locked in the filter system.

By providing a first seal member wherein the second circumferential sealing portion has a contour shape with single-fold rotational symmetry, the main filter element can only be coupled to the safety filter element in one way such that the second circumferential sealing portion of the first seal member sealingly cooperates with the sealing surface of the main filter element. This reduces the risk of wrongly installing the main filter element and facilitates the maintenance procedure as there is only one straightforward way of coupling the main filter element to the safety filter element.

As a result of the characteristic features of the safety filter element according to the present disclosure, the main filter element is also simplified as it requires less components, which reduces cost and facilities the manufacturing procedure of the main filter element. Indeed, with the safety filter element according to the present disclosure, the main filter element does not require a seal member, nor does it require a protecting shell as the shell of the safety filter element is used to protect the primary filter medium pack.

In embodiments, the first seal member is permanently coupled to shell by sealingly attaching the first circumferential sealing portion to the shell. For example, by using an adhesive or, alternatively, by overmolding the first seal member onto the shell via multi-component injection molding.

In other embodiments, the first seal member is removably coupled to the shell such that the first seal member can be replaced without replacing the shell.

In embodiments where the first seal member for sealing the safety filter element to the main filter element is permanently coupled to the shell of the safety filter, the first seal member remains in place when replacing the main filter element. In this way, the first seal member can be used multiple times with different main filter elements. Only when the first seal member needs replacement, which is at lower frequency than the replacement of the main filter medium pack, the safety filter element is to be removed from the filter system.

In embodiments, the first seal member is a lip-type seal member comprising at least one sealing lip, and wherein the at least one sealing lip is forming the second circumferential sealing portion of the first seal member for sealing the safety filter element to the main filter element.

In embodiments, the safety filter element comprises a connecting arrangement for locking the safety filter element to a housing of a filter system. Generally, the connecting arrangement is coupled to the shell.

Advantageously, by providing a connecting arrangement for locking the safety filter element to a housing of a filter system, the safety filter element is locked to the housing of the filter system independently of the locking of a cover or a pre-cleaner to the housing of the filter system. Hence, when replacing the main filter element, the safety filter element remains locked within the housing of the filter system.

In embodiments, the safety filter element comprises a second seal member for sealing the safety filter element to a housing of a filter system. The second seal member can either be a permanent seal that is permanently coupled to the shell or alternatively, the second seal member can be removably coupled to the shell. Preferably the second seal member is coupled to an outer side of the circumferential wall of the shell.

In embodiments, the second seal member comprises an inner circumferential side for sealing to the shell and an outer circumferential side for sealing to the housing, and wherein the inner circumferential side is coupled to an outer side of the circumferential wall of the shell. Preferably, the outer circumferential side of the second seal member comprises one or more sealing lips.

According to a second aspect of the disclosure, a filter assembly is provided comprising a safety filter element and a main filter element. The main filter element comprises a primary filter medium pack that is receivable in the cavity of the safety filter element and the main filter element further comprises a circumferential frame sealingly attached to the primary filter medium pack. The circumferential frame comprises a circumferential sealing surface configured for sealingly cooperating with the second circumferential sealing portion of the first seal member when the primary filter medium pack of the main filter element is received in the cavity.

In embodiments, the filter assembly according to the present disclosure is a filter assembly for air cleaning.

According to a third aspect of the present disclosure, a filter system is provided comprising a filter assembly according to the present disclosure and a housing for housing the filter assembly.

### SHORT DESCRIPTION OF THE DRAWINGS

These and further aspects of the present disclosure will be explained in greater detail by way of example and with reference to the accompanying drawings in which:

FIG. 1a to FIG. 1e schematically illustrate various views of a first embodiment of a safety filter element according to the present disclosure. FIG. 1a is a top view wherein the dashed arrows B, C, D indicate view directions of, respectively, FIG. 1b, FIG. 1c, and FIG. 1d, while FIG. 1e is an enlarged view of a portion of the safety filter indicated on FIG. 1d with the dashed arrow E.

FIG. 2a is an isometric view of an embodiment of a filter assembly comprising a safety filter element and a main filter element.

FIG. 2b represents a side view of the filter assembly shown on FIG. 2a after the primary filter medium pack is received in the cavity of the safety filter element.

FIG. 2c is an enlarged cross-sectional view of a portion of the filter assembly shown on FIG. 2a.

FIG. 3a schematically illustrates a cross-section of a safety filter element embodiment wherein the first seal member is coupled to the inner wall of the shell for forming a radial seal.

FIG. 3b schematically illustrates a cross-section of a safety filter element embodiment wherein the shell comprises a flange and wherein the first seal member is coupled to the flange for forming an axial seal.

FIG. 3c schematically illustrates a cross-section of a safety filter element embodiment wherein a first shell portion surrounding the secondary filter medium pack has a different circumference than a second shell portion for receiving the main filter medium pack.

FIG. 3d schematically illustrates a cross-section of a safety filter element embodiment wherein the shell comprises a flange positioned at an oblique angle with respect to the longitudinal direction.

FIG. 4a and FIG. 4b schematically illustrate embodiments of safety filter elements wherein the secondary filter medium pack is removable from the shell.

FIG. 5a and FIG. 5b illustrate two embodiments of a first seal member wherein a second circumferential sealing portion has a contour shape of single-fold rotational symmetry.

FIG. 6 shows an isometric view of an example of an embodiment of a main filter element insertable in the safety filter element illustrated in FIG. 1a to FIG. 1e.

FIG. 7 shows a cross-sectional view of a filter system comprising a housing, a safety filter element, a main filter element, and a pre-cleaner.

FIG. 8 shows an enlarged cross-sectional view of a portion of the filter system of FIG. 7, illustrating the first seal member sealing to the main filter element and the second seal member sealing to a wall of the housing.

FIG. 9 to FIG. 37 illustrate a preferred embodiment of an air cleaner assembly, a safety filter element, a main filter element, and a housing (including a main housing part and precleaner or cover part) of the present disclosure.

FIGS. 9 to 12 are exploded views of the assembly from four different angles.

FIGS. 13 to 15 are cut views along different cutting planes of the filter assembly.

FIGS. 16 to 18 are exploded cut views of the filter assembly along different cutting planes.

FIGS. 19 to 21 are different perspective views of the safety filter element.

FIGS. 22 to 24 are different perspective cut views of the safety filter element.

FIGS. 25 and 26 are different perspective views of the main filter element.

FIGS. 27 to 29 are different perspective cut views of the main filter element.

FIGS. 30 to 32 are different perspective cut views of the combination of safety and main filter element.

FIGS. 33 and 34 are different perspective cut views of the combination of the safety element and the filter housing (main housing part).

FIGS. 35 to 37 are perspective cut views of the filter assembly, similar to FIGS. 13 to 15 but excluding the cover or portion of a precleaner arrangement.

### DETAILED DESCRIPTION

The present disclosure will be described in terms of specific embodiments, which are illustrative of the disclosure and not to be construed as limiting. It will be appreciated by persons skilled in the art that the present disclosure is not limited by what has been particularly shown and/or described and that alternatives or modified embodiments could be developed in the light of the overall teaching of this disclosure. The drawings described are only schematic and are non-limiting.

Use of the verb “to comprise”, as well as the respective conjugations, does not exclude the presence of elements other than those stated. Use of the article “a”, “an” or “the” preceding an element does not exclude the presence of a plurality of such elements.

Furthermore, the terms first, second, and the like in the description and in the claims are used for distinguishing between similar elements and not necessarily for describing a sequence, either temporally, spatially, in ranking or in any other manner. It is to be understood that the terms so used are interchangeable under appropriate circumstances and that the embodiments of the disclosure described herein are capable of operation in other sequences than described or illustrated herein.

Reference throughout this specification to “one embodiment” or “an embodiment” means that a particular feature, structure or characteristic described in connection with the embodiments is included in one or more embodiment of the present disclosure. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one ordinary skill in the art from this disclosure, in one or more embodiments.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

### Single-Fold Rotational Symmetry and Mirror Symmetry, Definitions

The concept of single-fold rotational symmetry is well known in the art. When throughout the present disclosure, a contour shape, such as for example, a contour shape of a second circumferential sealing portion of a seal member, is specified to have “single-fold rotational symmetry”, it has to be construed as a contour shape that has no rotational symmetry, i.e., it has no axis of rotational symmetry.

Single-fold rotational symmetry is also commonly named discrete rotational symmetry of the first order, i.e., for any rotation axis selected, when rotating the object having the contour shape, only after a rotation of 360°, the contour shape matches up, i.e., only after a 360° rotation the contour shape looks the same as at the start of the rotation. In contrast, with rotational symmetric contour shapes having, for example, an N-fold rotational symmetry, with N>1, a contour looks the same after a rotation of 360°/N. Rotational symmetric contour shapes have a rotation axis of order N, with N>1. Contour shapes with single-fold rotational symmetry have no axis of rotational symmetry, in contrast to rotational symmetric contour shapes that have a rotational axis such that after rotating around an angle of 180° or less around the rotation axis, the rotated contour shape matches up as it was in its initial position.

When the wording “mirror symmetry” or “mirror symmetric” is used throughout the present disclosure, it has to be construed as reflection symmetry, i.e., when in three dimensions, a mirror-symmetric object or mirror-symmetric contour comprises a plane of mirror symmetry, further named mirror plane. For each half of a mirror-symmetric object or contour shape on a first side of the plane of mirror symmetry, there is another half object or half contour shape on a second side of the plane of mirror symmetry, such that every point of the half object or half contour shape on the first side has a one-to-one equidistant mapping onto another point of the other half object or contour shape on the second side of the plane of mirror symmetry. When in two dimensions, mirror symmetry implies the presence of an axis of symmetry and when folding the two-dimensional object in half over the axis of symmetry, the two halves would be identical.

### Safety Filter Element

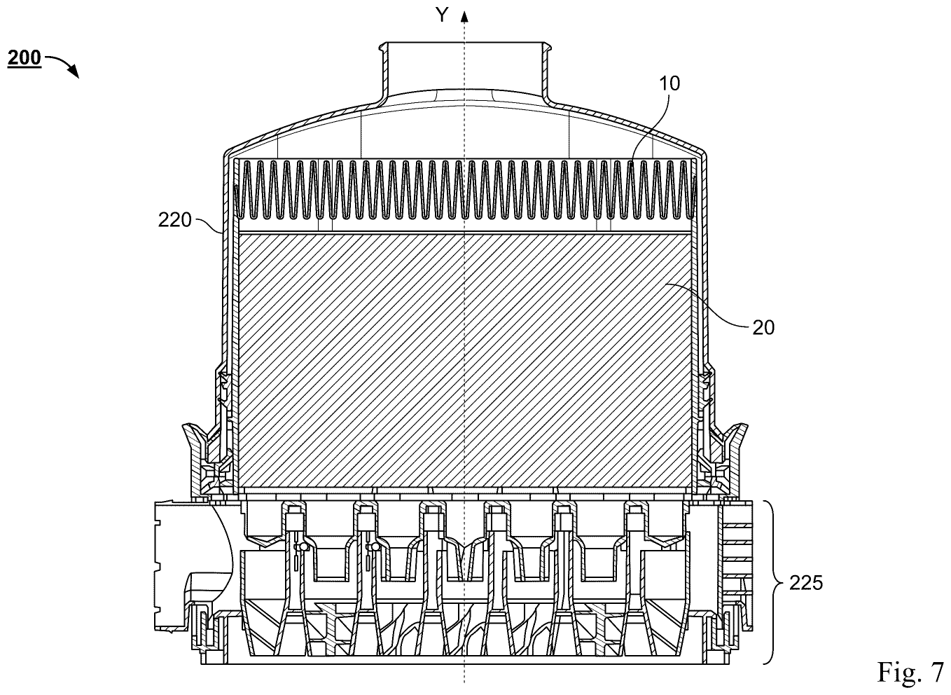

According to a first aspect of the present disclosure, a safety filter element is provided. The safety filter element is an element for backing up failure of a main filter element comprising a primary filter medium pack. The safety filter element and the main filter element are components to be installed in a housing of a filter system, as illustrated, for example, in FIG. 7 wherein a housing 220 of a filter system 200 is shown that comprises a main filter element having a primary filter medium pack 20 and a safety filter element having a secondary filter medium pack 10. The main filter element and the safety filter element are structurally separated components in the sense that the main filter element is removable from the housing without having to remove the safety filter element.

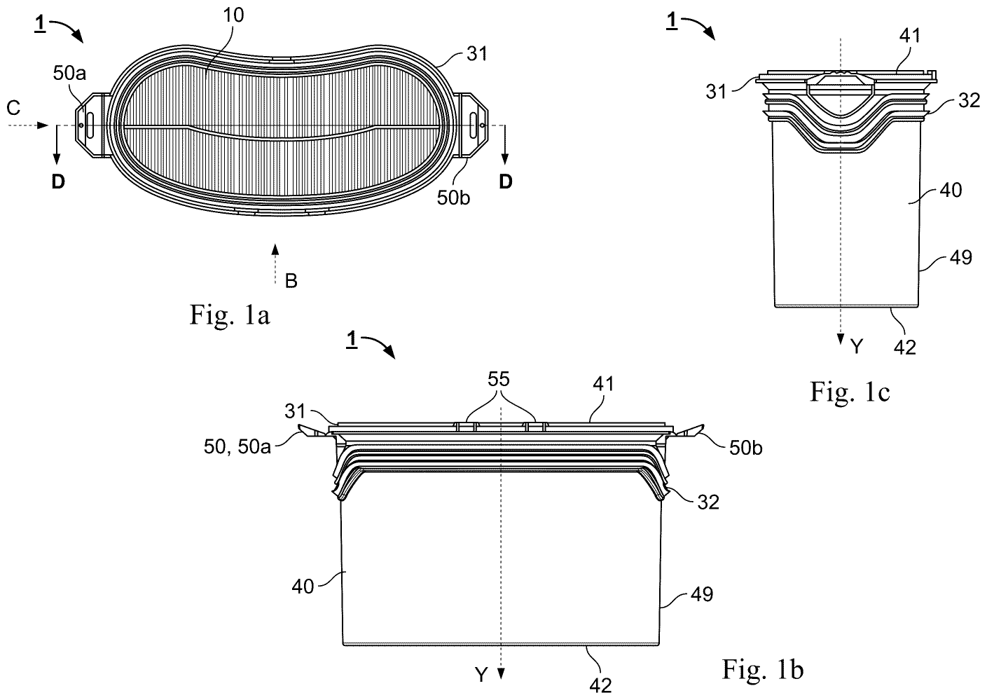

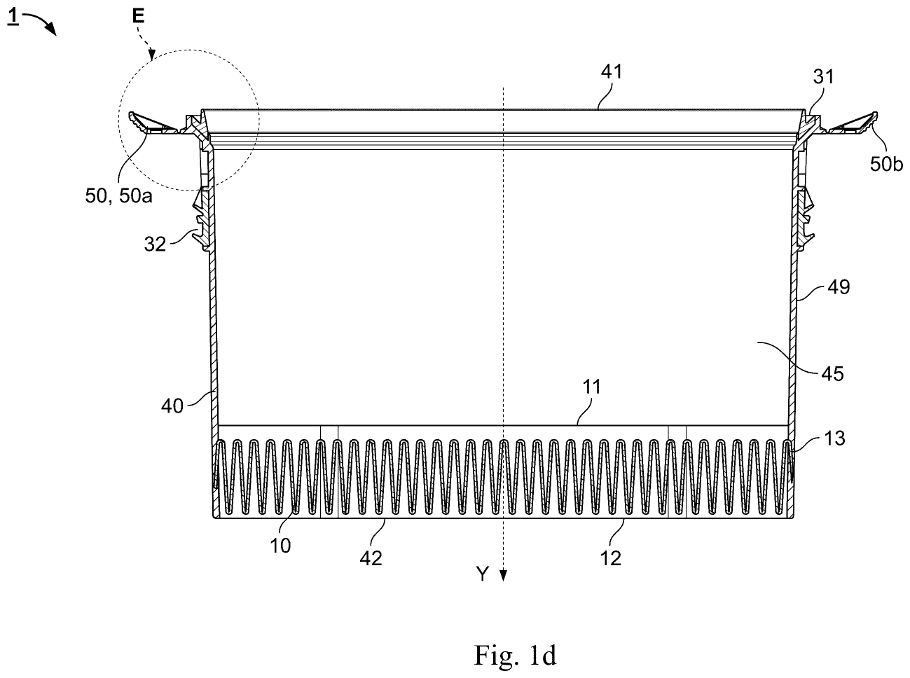

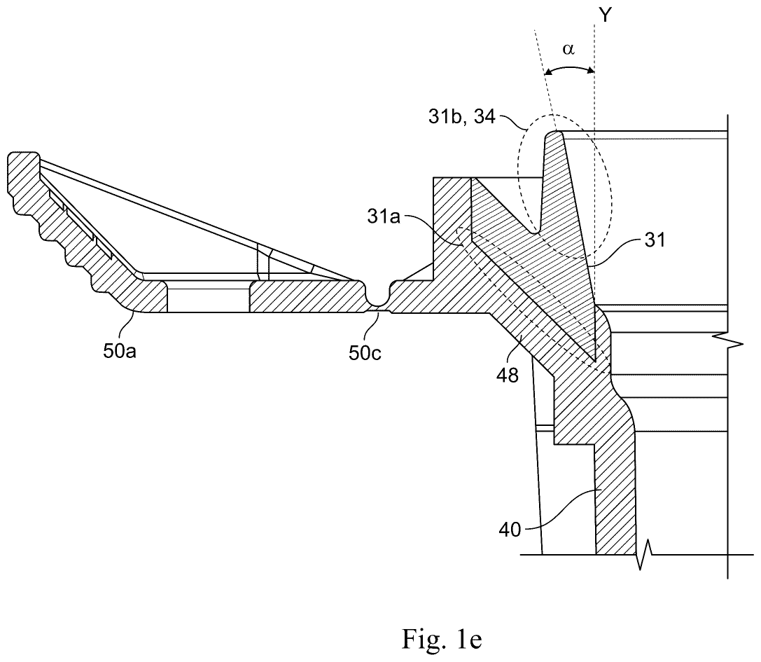

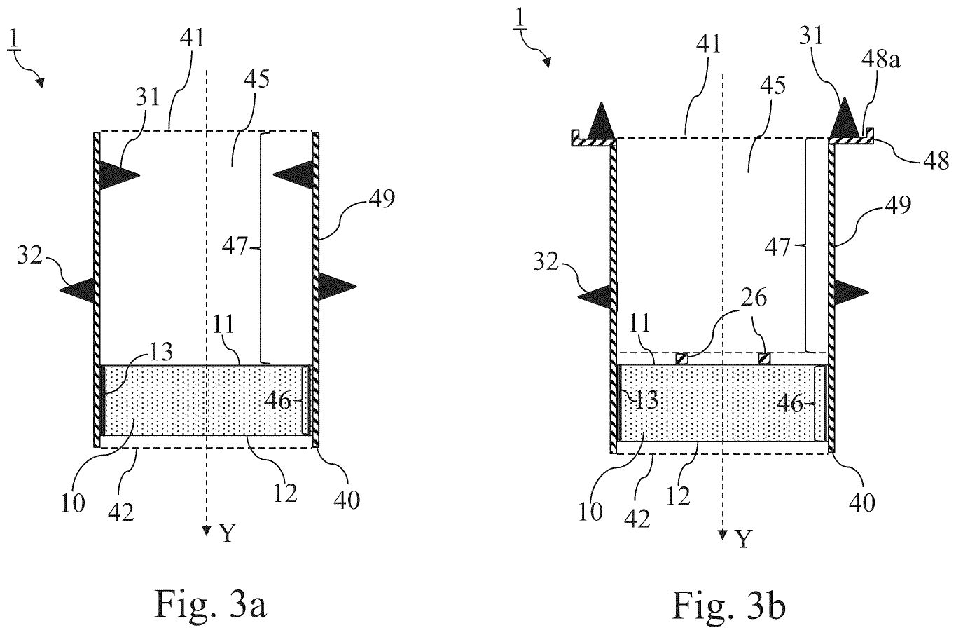

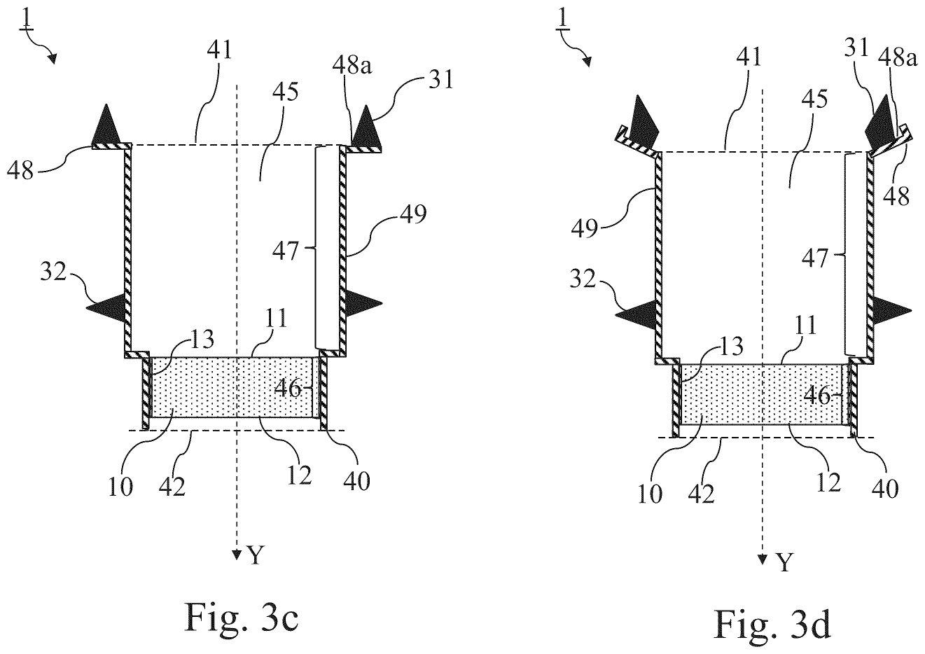

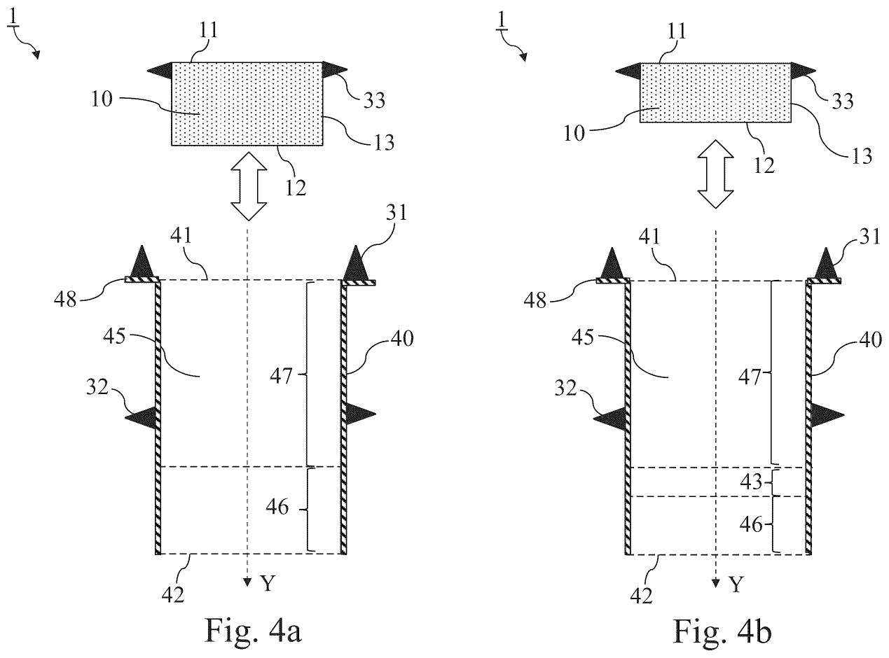

With reference to FIG. 1a to FIG. 1e, FIG. 3a to FIG. 3d, FIG. 4a and FIG. 4b, various examples of embodiments of a safety filter element 1 according to the present disclosure are shown, and which are further discussed below.

The safety filter element 1 comprises a secondary filter medium pack 10 having a fluid inlet side 11, a fluid outlet side 12 opposite the fluid inlet side, and a circumferential side 13 extending in a longitudinal direction Y from the fluid inlet side to the fluid outlet side. In other words, the secondary filter medium pack is a so-called straight-through flow filter arrangement. In one aspect, direction Y in FIGS. 1b-1d can also be characterized as being a central longitudinal axis of the safety filter element 1, which also defines a central longitudinal axis of the secondary filter medium pack 10.

The secondary filter medium pack 10 can comprise any suitable filter media. In embodiments, the secondary filter medium pack 10 comprises pleated filter media. In other embodiments, the secondary filter medium pack 10 comprises fluted filter media. In embodiments, the fluted filter media comprise, for example, coiled layers of fluted filter material wherein an outer surface of an outer layer of the coiled fluted filter media is forming the outer circumferential side 13 of the secondary filter medium pack 10. Typically, each of the coiled layers of fluted filter material comprises inlet flutes and outlet flutes, preferably oriented essentially parallel with the longitudinal direction.

The safety filter element 1 further comprises a shell 40. The shell comprises a circumferential wall 49 extending in the longitudinal direction Y from a first opening 41 at a first end of the shell to a second opening 42 at a second end of the shell. The shell is also named casing. A first portion 46 of an inner side of the circumferential wall 49 of the shell is surrounding the circumferential side 13 of the secondary filter medium pack 10 and a second portion 47 of the inner side of the circumferential wall of the shell is radially delimiting a cavity 45 located between the first opening 41 of the shell and the fluid inlet side 11 of the secondary filter medium pack. The cavity allows the shell to receive or at least partially receive the primary filter medium pack of the main filter element.

With reference to FIG. 4a and FIG. 4b, an embodiment is shown wherein the secondary filter medium pack 10 is removable from the shell. In FIG. 4a, the first and second inner wall portions 46, 47 of the shell, as defined above, are indicated. In embodiments, after the cavity of the shell has received the primary filter medium pack, a longitudinal spacing between the primary and secondary filter medium packs might remain, which is indicated in FIG. 4b where wherein the inner wall of the shell comprises a third wall portion 43 between the first and second wall portions 46, 47.

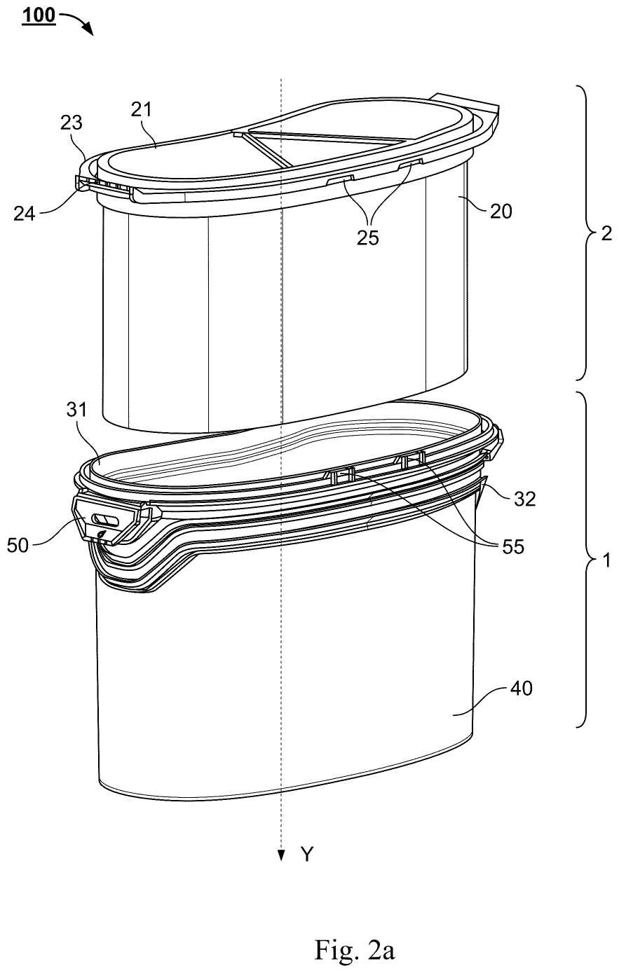

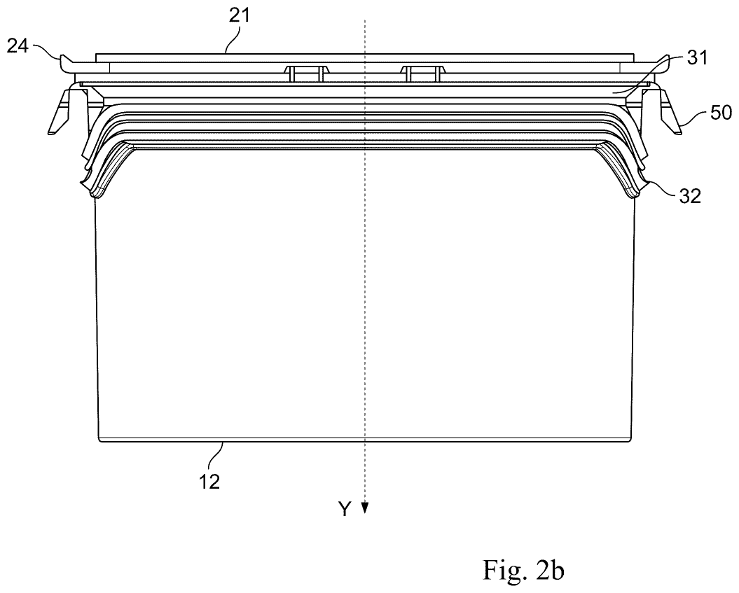

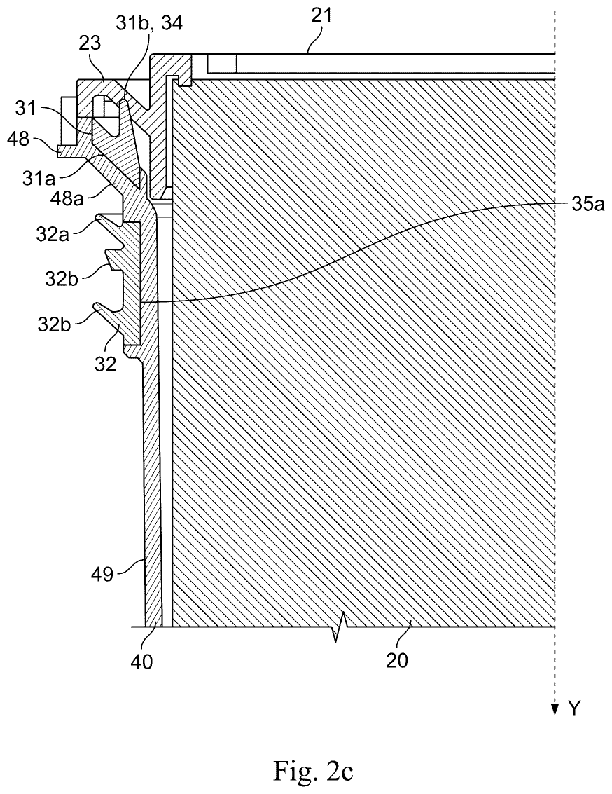

The shell 40 advantageously protects not only the circumferential side of the secondary filter medium pack from damage that could be caused by the housing body or caused during handling, but at the same time, when the main filter element is installed, it also protects the circumferential side of the primary filter medium pack from damage. Hence, there is no need to place a dedicated shell around the primary filter medium pack. With reference to FIG. 2a and FIG. 2b, a filter assembly 100 is shown comprising a safety filter element 1 and a main filter element 2, wherein, after installation of the main filter element 2, the shell 40 of the safety filter element entirely surrounds the primary filter medium pack.

The first inner wall portion 46 and the second inner wall portion 47 of shell 40 do not necessarily have the same circumferential size. This is illustrated in FIG. 3c and FIG. 3d where a cross-section of an embodiment of a safety filter element is shown, wherein a first shell portion surrounding the secondary filter medium pack has a smaller circumference than a second shell portion defining the cavity for receiving the main filter medium pack. For example, if the circumference of the secondary filter medium pack is different from the circumference of the primary filter medium pack, the shell 40 can be configured to have two shell portions having inner wall portions that match with the outer circumferential face of, respectively, the primary and secondary filter medium packs.

In embodiments, the shell is made of or at least partially made of a thermoplastic material. Preferably, the thermoplastic material is any of the following materials or mixtures and combinations thereof: acrylonitrile butadiene styrene, polypropylene, polyamide, polyethylene terephthalate, polylactic acid, polyethylene, polycarbonate, polystyrene, or polyvinyl chloride.

The safety filter element according to the present disclosure comprises at least a first seal member 31 that is supported by the shell 40. The first seal member 31 is a seal for sealing the safety filter element to the main filter element. Indeed, as the safety filter element and main filter element are separate components, when coupling the main filter element with the safety filter element by inserting the primary filter medium pack into the cavity of the safety filter element, a circumferential gap exists between the main filter element and the safety filter element. More specifically, the seal member 31 is a seal configured for sealing the gap between the second portion 47 of the inner wall of the shell 40 and the primary filter medium pack when the primary filter medium pack is received within the cavity 45. In other words, the first seal member 31 ensures that incoming dirty fluid, e.g., dirty air, to be filtered by the primary filter medium pack, does not bypass the primary filter medium pack and that the clean fluid, e.g., clean air, exiting the primary filter medium pack further flows through the secondary filter medium pack.

The first seal member 31 is a three-dimensional component of the safety filter element 1, and the first seal member generally comprises a number of circumferential sides. For example, there is at least one circumferential side of the first seal member, more generally named first circumferential sealing portion 31a, to form a sealed coupling to the shell 40, and there is at least another circumferential side, or more generally named a second circumferential sealing portion 31b, that is to form a sealed coupling with an external component, i.e., external to the safety filter element, in this case with the main filter element. The second circumferential sealing portion 31b of the first seal member 31 is that portion of the seal member that is cooperating with a sealing surface of the main filter element when the cavity of the safety filter element has received the primary filter medium pack of the main filter element. In other words, the second circumferential sealing portion 31b of the first seal member 31 is that portion that seals off the circumferential gap between the main filter element and the safety filter element when the cavity of the safety filter element has received the primary filter medium pack.

The safety filter element according to the present disclosure is characterized in that the second circumferential sealing portion 31b of the first seal member 31 has a contour shape of single-fold rotational symmetry. In other words, there exists no axis of rotational symmetry for this contour shape. Hence, even for embodiments where the safety filter element comprises a central longitudinal axis, the central longitudinal axis is not an axis of rotational symmetry for this contour shape. In this way, when installing the main filter element, there is only one way to insert the primary filter medium pack into the cavity of the safety filter element such that the second circumferential sealing portion 31b of the first seal member matches with a corresponding sealing surface of the main filter element.

In embodiments, the first seal member 31 of the safety filter element 1 according to the present disclosure is permanently coupled to the shell 40. Permanently coupled has to be construed as non-removably coupled. Hence, if following maintenance procedures, the first seal member 31 needs replacement, at least the shell 40 together with first seal member 31 needs to be replaced. The first seal member 31 becomes permanently coupled to the shell 40 by sealingly attaching the first circumferential sealing portion 31a to the shell 40. This attachment can be performed, for example, by using an adhesive, such as a glue. Alternatively, the first circumferential sealing portion 31a becomes sealingly attached to the shell 40 by using a multi-component injection molding technique when manufacturing the shell such that the shell 40 and the first seal member 31 form a single body.

In other embodiments, the first seal member 31 is removably coupled to the shell, i.e., in these embodiments, the first seal member is a replaceable seal such that, for example, during maintenance operations, the first seal member can be replaced without having to replace the shell 40. In these embodiments, the first seal member 31 rests, for example, on a seal support flange 48 of the shell 40, or if the first seal member 31 is coupled to the circumferential wall 49 of the shell 40, a groove or indentation can be made in the circumferential wall 49 to support the first seal member 31.

In embodiments, as illustrated for example in FIG. 1e, FIG. 2c, and FIG. 3b to FIG. 3d, the shell 40 comprises a seal support flange 48 located at the first end of the shell 40. The seal support flange 48 has to be construed as a projecting collar or rim that is forming a supporting element for supporting the first seal member. The first seal member 31 is coupled, either removably or permanently, to the seal support flange 48.

Generally, as indicated on FIG. 3b to FIG. 3d, the seal support flange 48 comprises a circumferential support surface 48a wherein the first circumferential sealing portion 31a of the first seal member 31 is coupled, either permanently coupled or removably coupled, to the circumferential support surface 48a.

In embodiments, as schematically shown on FIG. 3b and FIG. 3c, the seal support flange 48 is radially projecting with respect to the longitudinal direction Y. In these embodiments, the support flange 48 comprises a circumferential support surface 48a for supporting the first seal member 31 that is essentially perpendicular to the longitudinal direction Y.

In other embodiments, as schematically illustrated on FIG. 1e, FIG. 2c, and FIG. 3d, the seal supporting flange 48 is disposed at an oblique angle with respect to the longitudinal direction Y. This allows a compact integration of the safety filter element within a housing 220 of a filter system, wherein un-useful space between the safety filter element and inner walls of the housing of the filter system can be reduced.

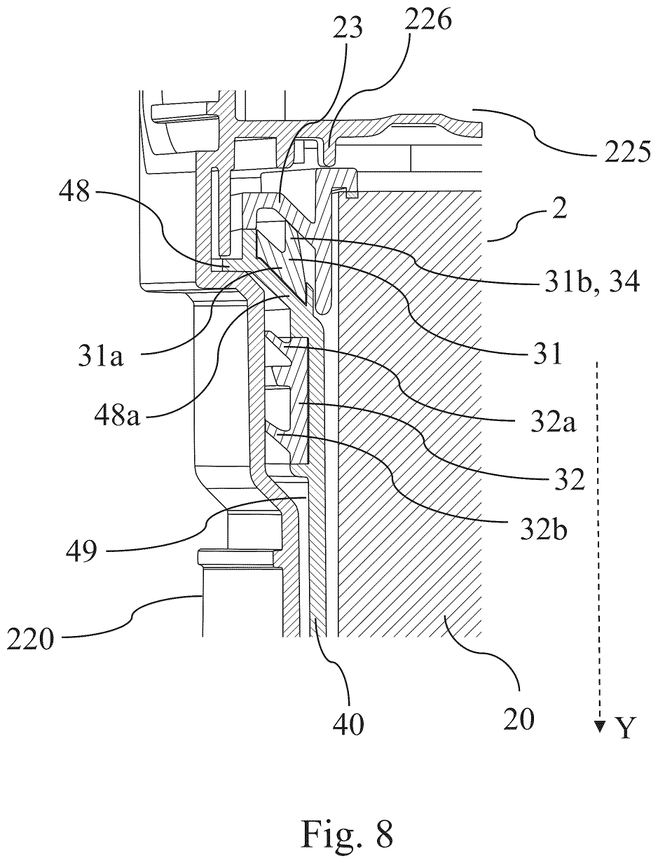

In embodiments, as illustrated on FIG. 2c, FIG. 3d, and FIG. 8, the seal supporting flange 48 comprises a circumferential support surface 48a for supporting the first seal member 31 wherein the circumferential support surface 48a is disposed at an oblique angle with respect to the longitudinal direction Y. This allows to provide for a compact first seal member geometry and provide for a compact integration of the safety filter element in a housing of a filter system.

In embodiments, the first seal member 31 is made of or at least partially made of any of the following list of materials or a mixture or combination thereof: rubber, thermoplastic elastomer, thermoset elastomer, and thermoplastic vulcanizate.

Advantageously, in embodiments, the first seal member 31 is overmolded onto the shell 40 via injection molding such that the shell and the first seal member are forming a single body. Injecting molding, more precisely multi-component injection molding, is a manufacturing process wherein at least a first and a second component of the multi-component injection molding process correspond to respectively the material of the shell 40 and the material of the first seal member 31.

In further embodiments, the first seal member 31 is made of or at least partly made of polyurethane (PU) material, for example, forming a foamed polyurethane seal. The PU material can be molded onto the shell 40 or alternatively, the first seal member can be independently molded from a PU material and be further secured to the shell with an adhesive.

The safety filter elements of the present disclosure have in common that the first seal member 31 is coupled to the shell 40, but the location of the first seal member 31 with respect to the shell 40 can vary from embodiment to embodiment. With reference to FIG. 1a to FIG. 1e, FIG. 3b, and FIG. 4a, examples of safety filter elements are shown wherein the first seal member 31 is coupled to the first end of the shell 40.

In embodiments where the first seal member 31 is coupled to the first end of the shell 40, the first seal member 31 is, for example, configured for forming an axial seal with respect to the longitudinal direction Y, as schematically illustrated in FIG. 3b and FIG. 3c. An axial seal is a seal that essentially seals in the axial direction, i.e., in a direction parallel with the longitudinal direction Y.

In further embodiments, as schematically illustrated on FIG. 3a, the first seal member 31 is coupled to the inner wall of the shell 40, more precisely to the second inner wall portion 47 of the shell. In this way, the first seal member 31 is forming a radial seal with respect to the longitudinal direction. A radial seal is a seal that seals or at least partly seals in a radial direction, i.e., in a direction transverse to the longitudinal direction Y.

With reference to FIG. 1a, a top view of an embodiment of the safety filter element is shown where the first seal member 31 follows the contour shape of the shell 40, which in this example, has the shape of a banana, i.e., a shape with single-fold rotational symmetry. As the first seal member 31 is following the contour shape of the shell having single-fold rotational symmetry, the second circumferential sealing portion 31b of the first seal member has also a contour shape of single-fold rotational symmetry.

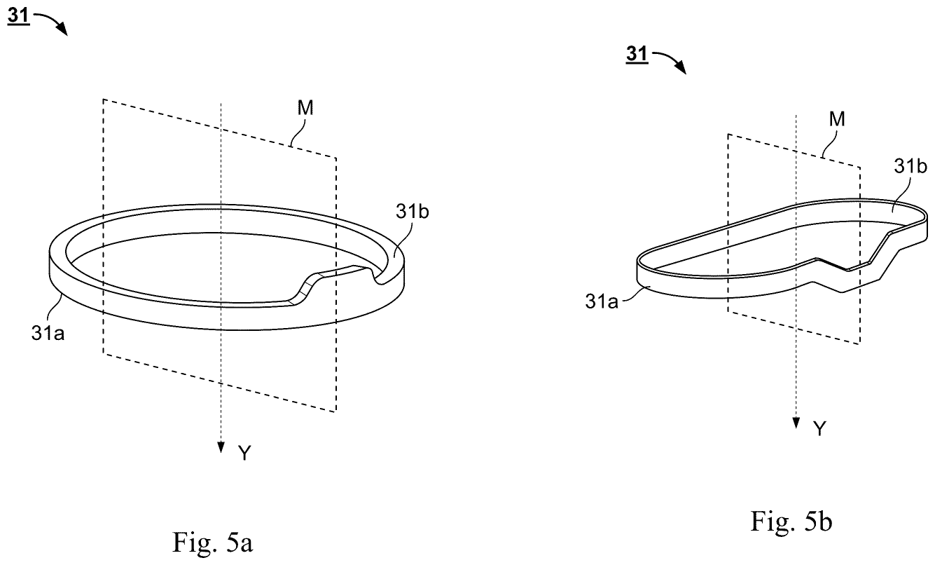

With reference to FIG. 5a, a first seal member 31 is shown comprising a first circumferential sealing portion 31a for sealing to the shell 40 and a second circumferential sealing portion 31b for sealing to the main filter element, and wherein the second circumferential sealing portion 31b has a contour shape of single-fold rotational symmetry. As shown in FIG. 5a, the single-fold rotational symmetry is obtained by providing a seal member 31 with a single axial step in the axial direction. In this example, the first seal member 31 is an axial seal that is used, for example, with the safety filter element shown in FIG. 3b or FIG. 3c where the first seal member 31 is axially coupled to a seal support flange 48 of the shell. More precisely, the first circumferential sealing portion 31a, opposite the second circumferential sealing portion 31b, can be axially coupled to the circumferential support surface 48a of the flange 48. In this example, the shell 40 and/or the seal support flange 48 can have a rotational symmetric shape, e.g., a circular contour shape, while the second circumferential sealing portion 31b has a contour shape of single-fold rotational symmetry. In the example shown on FIG. 5a, the first circumferential sealing portion 31a has a contour shape that is rotational symmetric with respect to the longitudinal axis Y.

With reference to FIG. 5b, a further embodiment of a first seal member 31 is shown comprising a first circumferential sealing portion 31a for sealing to the shell 40 and a second circumferential sealing portion 31b for sealing to the main filter element, wherein the second circumferential sealing portion 31b has a contour shape of single-fold rotational symmetry. In this example, the first seal member 31 has the shape of a band, wherein the second circumferential sealing portion 31b is the inner side of the band-shaped first seal member 31 and the first sealing portion 31a is the outer side of the band-shaped seal member 31. In this example, the first seal member 31 is a radial seal that can be used in combination with, for example, the safety filter element shown in FIG. 3a by coupling the outer side of the band-shaped seal member to the inner side of the circumferential wall 49 of the shell 40. In this example, the inner side of the circumferential wall 49 receiving the first seal member shown on FIG. 5b has a two-fold rotational symmetry with respect to the longitudinal direction Y, while the contour shape of the second circumferential sealing portion 31b has a single-fold rotational symmetry. In this example of a band-shaped seal member, both the first and second circumferential sealing portions 31a, 31b have a contour shape of single-fold rotational symmetry.

In embodiments, as illustrated for example on FIG. 2a and FIG. 2c, the first seal member 31 is a lip-type seal member. A lip-type seal member is a seal member that comprises at least one sealing lip 34. In these embodiments, the at least one sealing lip 34 is forming the second circumferential sealing portion 31b of the first seal member 31.

The first seal member 31 of the safety filter element 1 of FIG. 2a is shown in more detail on FIG. 1e and FIG. 2c, wherein the first seal member 31 has been colored in black. As shown on FIG. 1e and FIG. 2c, the first seal member 31 is a lip seal that in this example comprises one sealing lip 34. As mentioned above, the sealing lip 34 is forming the second circumferential sealing portion 31b for sealing the safety filter element to the main filter element. In this example, the first seal member 31 is coupled to a seal support flange 48, more precisely, the first circumferential sealing portion 31a is coupled to the seal support flange 48. In embodiments, the first circumferential sealing portion 31a can be permanently coupled to the seal support flange 48 by an adhesive, such as a glue, or be permanently coupled during the manufacturing process of the shell by injection molding. In other embodiments, the first seal member 31 is a removable seal member and the first seal member rests with its first circumferential sealing portion 31a on the seal support flange 48.

In embodiments where the first seal member 31 is a lip-type seal member comprising at least one sealing lip 34, the at least one sealing lip 34 is disposed at an oblique angle with respect to the longitudinal direction Y, as illustrated on FIG. 1e and FIG. 2c. This oblique angle is present when the sealing lip 34 is in un-sealed position. When in sealed position, a pressure is exercised on the sealing lip 34 such that the sealing lip further bends.

In embodiments, the at least one sealing lip 34 is outwardly inclined by an angle α with respect to the longitudinal direction Y, as illustrated on FIG. 1e. Preferably the angle α is at least 5°, more preferably at least 10°. This angle is present when in an un-sealed position. When in a sealed position, the angle can further become larger. For example, when the main filter element is inserted in the safety filter element and a cover or pre-cleaner is placed on the housing of the filter system, a circumferential frame 23 of the main filter element exercises a pressure on the sealing lip such that the oblique sealing lip further inclines outwardly for forming a leak-tight seal between the safety filter element and the main filter element.

In embodiments, in addition to the single-fold rotational symmetry of the contour shape of the second circumferential sealing portion of the first seal member 31, the contour shape of the second circumferential sealing portion 31b further has a plane of mirror symmetry M that is crossing the fluid inlet side and the fluid outlet side of the secondary filter medium pack. In the examples of first seal members 31 shown in FIG. 5a and FIG. 5b, the second circumferential sealing portion 31b has a plane of mirror symmetry, indicated with the letter M. When the first seal member 31 is coupled to the shell of the safety filter element, the plane of mirror symmetry M crosses the fluid inlet side and the fluid outlet side of the secondary filter medium pack.

In embodiments, the contour shape of the second portion 47 of the inner wall of the shell 40 has a single-fold rotational symmetry. For example, if the contour shape of the primary filter medium pack has a single-fold rotational symmetry, the contour shape of the second portion 47 of the inner wall of the shell can be configured for matching with the contour shape of the circumferential face of the primary filter medium pack.

With reference to the embodiment illustrated in FIG. 1a to FIG. 1e, not only the first seal member 31 has a second circumferential sealing portion 31b with single-fold rotation symmetry, but also the shell 40 itself has a single-fold rotational symmetry. In this embodiment, the contour shape of the second circumferential sealing portion 31b of first seal member 31 is following the circumferential contour shape of an outer circumferential wall of the shell 40. In this embodiment, both the outer and the inner contour shapes of the shell have a single-fold rotational symmetry.

In other embodiments, the shell 40, or more precisely the circumferential wall 49 of the shell can be rotational symmetric with respect to an axis of rotation that is parallel with the longitudinal direction Y. As discussed above, the first seal member 31 can, for example, be coupled to an end of the shell, as schematically illustrated in FIG. 3b. As discussed above, an example of a first seal member 31 wherein the contour shape of the second circumferential sealing portion has a single-fold rotational symmetry and that can be coupled to a rotational symmetric shell is shown in FIG. 5a. Such a first seal member is, for example, forming an axial seal for sealing in an axial direction parallel with the longitudinal direction.

In embodiments, the shell has a discrete N-fold rotational symmetry with respect to an axis of rotation parallel with the longitudinal direction Y, with N>1.

An example of a first seal member 31, wherein the contour shape of the second circumferential sealing portion 31b has single-fold rotational symmetry, and that can be used in combination with a shell having a two-fold rotational symmetry with respect to a rotational axis parallel with the longitudinal direction, is shown in FIG. 5b.

In embodiments, a cross-section between the outer side of the circumferential wall 49 of the shell 40 and a plane transverse to the longitudinal direction Y has a shape selected of any of the following shapes: round, obround, race-track shape, peanut shape, banana shape, elliptical shape, square, and rectangular.

In embodiments, a cross section between the second portion 47 of the inner side of the circumferential wall 49 of the shell 40 and a plane transverse to the longitudinal direction Y has a shape selected of any of the following shapes: round, obround, race-track shape, peanut shape, banana shape, elliptical shape, square, and rectangular.

In embodiments, the safety filter element according to the present disclosure comprises a connecting arrangement 50 coupled to the shell 40 and configured for locking the safety filter element 1 to a housing of a filter system. In this way, during maintenance operations, when the main filter element is to be replaced, the connecting arrangement maintains the safety filter element locked in place in the housing of the filter system.

In embodiments, the connecting arrangement 50 comprises any or a combination of: one or more latches, one or more snap-fit connectors, one or more pivoting connectors, one or more hinges, or one or more screws.

The connecting arrangement 50 can be coupled to the shell by an adhesive or the connecting arrangement 50 can be coupled to the shell by injection molding as part of the manufacturing process of the shell.

With reference to FIG. 1b, FIG. 1d, and FIG. 1e, an example is shown wherein the connecting arrangement 50 comprises two pivoting connectors 50a, 50b coupled to the shell. Each of the pivoting connectors is movable from a first position to a second position and configured such that when in the first position, the safety filter element is removable from the housing of the filter system and when in the second position, the pivoting connectors are engaging with corresponding engaging elements on the outer side of the housing so as to form a locked connection between the safety filter element and the housing.

In embodiments, as illustrated on FIG. 1e, the pivoting connector 50a can pivot around a pivoting axis 50c. In this embodiment, the pivoting connectors are made of a plastic material and are manufactured as part of the shell manufacturing process and the pivoting axis is obtained by locally reducing the thickness of the plastic material as illustrated on FIG. 1e.

In other embodiments, the connecting arrangement of the safety filter element comprises one or more engaging elements configured for engaging with corresponding connector elements of a housing of a filter system so as to lock the safety filter element to the housing of the filter system. Examples of engaging elements are: notches, slots, indentations, one or more latch receivers for engaging with corresponding one or more latches, or one or more snap-fit receivers for engaging with one or more corresponding snap-fit connectors.

In embodiments, the safety filter element according to the present disclosure comprises a second seal member 32 coupled to the shell. Preferably the second seal member 32 is coupled to an outer side of the circumferential wall 49 of the shell 40, as schematically illustrated in FIG. 3a to FIG. 3d.

The second seal member is a seal member for sealing the safety filter element to a housing of a filter system. Indeed, when the safety filter is installed in a housing of a filter system, the second seal member 32 seals to a sealing surface of the housing of the filter system. Advantageously, the second seal member 32 ensures that incoming dirty fluid, e.g., dirty air, does not bypass both the primary filter medium pack and the secondary filter medium pack through a gap between the outer side of the circumferential wall 49 of the shell and an inner wall of the housing.

In embodiments, the second seal member 32 is permanently, i.e., non-removably, coupled to the shell. In other embodiments, the second seal member 32 is a removable seal member, such as, for example, a gasket.

For the embodiment illustrated in FIG. 1a to FIG. 1d, the second seal member 32 is a lip-type seal member comprising one or more sealing lips 32a, 32b, as indicated at FIG. 2c. The sealing lips 32a, 32b are sealing lips for sealing to the housing.

In embodiments, as illustrated on FIG. 2c, the second seal member 32 comprises an inner circumferential side 35a for sealing to the shell 40 and an outer circumferential side 35b for sealing to the housing, wherein the inner circumferential side 35a is coupled to an outer side of the circumferential wall 49 of the shell 40. Generally, with this type of seal geometry, the second seal member is radially sealing or at least partly radially sealing the safety filter element to the housing of the filter system.

In embodiments, the outer circumferential side 35b of the second seal member 32 comprises one or more sealing lips 32a, 32b for sealing to the housing.

In embodiments, the second seal member 32 is made of or at least partially made of any of the following list of materials or a mixture or combination thereof: rubber, thermoplastic elastomer, thermoset elastomer, and thermoplastic vulcanizate. The second seal member 32 can, for example, be overmolded onto the shell 40 via multi-component injection molding.

In embodiments, both the first and second seal members 31, 32 are overmolded onto the shell via injection molding. In this way, a robust single body safety filter element is obtained that comprises at least the shell and both the first and second seal members.

In further embodiments, the second seal member 32 is made of or at least partly made of polyurethane material.

In embodiments, the secondary filter medium pack 10 is not removable from the shell 40. In these embodiments, the circumferential face of the secondary filter medium pack 10 is sealingly attached to the first portion 46 of the inner side of the circumferential wall of the shell, for example, by using an adhesive or by using an overmold manufacturing process.

In other embodiments, as schematically illustrated in FIG. 4a and FIG. 4b, the secondary filter medium pack 10 is removable from the shell such that it can be replaced without replacing the shell. In these embodiments, the safety filter element comprises a third seal member 33 configured for sealing a gap between the circumferential side 13 of the secondary filter medium pack 10 and the first portion 46 of the inner wall of the shell 40.

In embodiments, as illustrated in FIG. 1b and FIG. 2a, the seal support flange of the shell 40 comprises one or more first positioning elements 55 for facilitating the correct positioning of the main filter element 2 into the cavity 45 of the safety filter element. Those first positioning elements 55 are configured to engage with corresponding second positioning elements located on the main filter element 2. These positioning elements 55 facilitate positioning of the main filter element in the cavity of the safety filter element.

In the embodiments, the one or more first positioning elements 55 comprise any of or a combination of: a notch, an indentation, a depression, a ridge, a groove, or a slot.

In embodiments, as schematically illustrated in FIG. 3b, the safety filter element 1 comprises one or more rib elements 26 positioned essentially parallel with the fluid inlet side 11 of the secondary filter medium pack. Such a safety filter element with rib elements 26 is generally to be used in combination with a main filter element wherein the filter medium pack comprises flutes. Indeed, the one or more rib elements 26 act as an anti-telescopic frame to avoid the coiled layers of the primary fluted filter medium pack from moving in the longitudinal direction Y. This moving in the longitudinal direction is generally known as telescoping and results, for example, from the pressure difference between the inlet and outlet of the filter element or results as a consequence of vibrations. Hence, with the safety filter element comprising rib elements 26 according to the present disclosure, it is not needed to add a dedicated anti-telescopic frame to the main filter element and hence the manufacturing process of the main filter element can further be simplified.

### Filter Assembly

According to a second aspect of the present disclosure, a filter assembly 100 is provided comprising a safety filter element 1 according to the present disclosure and a main filter element 2. The main filter element 2 can be inserted and removed from the cavity of the safety filter element. In FIG. 2a and FIG. 2b, an example of an embodiment of a filter assembly is shown wherein the main filter element 2 is respectively removed from the cavity and inserted in the cavity of the safety filter element 1.

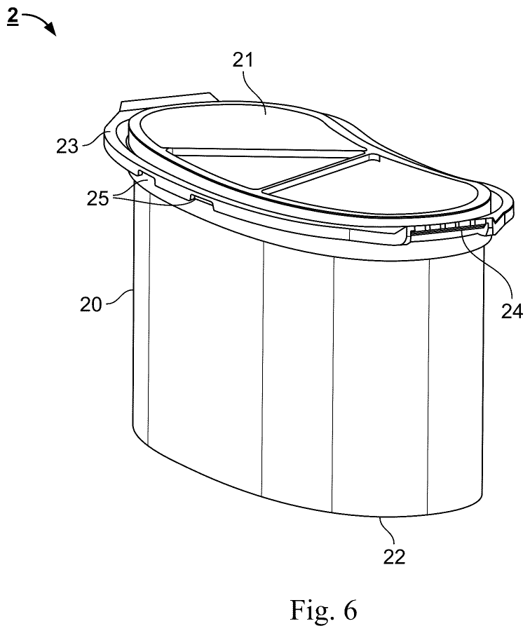

With reference to FIG. 6, an example of an embodiment of a main filter element is shown. The main filter element shown in FIG. 6 is an example of an embodiment of a main filter element that is insertable in the safety filter element illustrated in FIG. 1a to FIG. 1e.

The main filter element 2 of the filter assembly 100 comprises a primary filter medium pack 20 receivable in the cavity 45 of the safety filter element.

Typically, the primary filter medium pack 20 has an outer circumferential face extending in the longitudinal direction Y between a fluid inlet face 21 and a fluid outlet face 22 opposite the fluid inlet face 21. The main filter element 2 is configured such that when the primary filter medium pack 20 is received in the cavity of the safety filter element, the fluid outlet face 22 of the primary filter medium pack is facing the fluid inlet side 11 of the secondary filter medium pack. Hence, in these embodiments, the primary filter medium pack has to be construed as a flow-through filter medium pack.

In embodiments, the filter assembly according the primary filter medium pack 20 comprises fluted filter media. In embodiments, the fluted filter media comprise, for example, coiled layers of fluted filter material wherein an outer surface of an outer layer of the coiled fluted filter media is forming the outer circumferential face of the primary filter medium pack 20. Typically, each of the coiled layers of fluted filter material of the primary filter medium pack 20 comprises inlet flutes and outlet flutes, preferably oriented essentially parallel with the longitudinal direction Y.

As illustrated in FIG. 6, the main filter element 2 further comprises a circumferential frame 23 sealingly attached to the primary filter medium pack 20. The circumferential frame 23 comprises a circumferential sealing surface that is configured for sealingly cooperating with the first seal member 31 when the primary filter medium pack is received in the cavity 45.

The circumferential frame 23 is sealingly attached to the primary filter medium pack 20, for example, attached to the outer circumferential face of the primary filter medium pack. The attachment can be made by various means, for example, by thermal welding or by using an adhesive.

In embodiments, as illustrated in FIG. 6, the main filter element 2 comprises one or more handles 24 to facilitate the manipulation of the main filter element during maintenance.

As discussed above, in embodiments, the shell 40 of the safety filter element 1 comprises one or more first positioning elements 55 configured for engaging with corresponding second positioning elements 25 located on the main filter element 2 in order to facilitate correct positioning of the main filter element 2 into the safety filter element 1. In the embodiment shown in FIG. 6, the main filter element 2 further comprises second positioning elements 25 for engaging with the first positioning elements 55 of the safety filter element 1.

### Filter System

According to a third aspect of the present disclosure, a filter system is provided comprising a filter assembly as discussed above and a housing for housing the filter assembly.

With reference to FIG. 7, a filter system 200 is shown comprising a housing 220 that is housing a filter assembly according to the present disclosure, i.e., a filter assembly comprising a main filter element and a safety filter element. In this example, the filter system 200 comprises the filter assembly shown in FIG. 2a. In the embodiment shown in FIG. 7, the filter system also comprises a pre-cleaner 225 for pre-cleaning the fluid before entering the primary filter medium pack 20 of the main filter element.

With reference to FIG. 8, a cross-sectional view of a portion of the filter system of FIG. 7 is shown, illustrating the first seal member 31 for sealing to the main filter element 2 and the second seal member 32 for sealing to an inner wall of the housing 220. In this example, the first seal member 31 is a lip seal supported by an oblique flange 48 of the shell 40, wherein the lip seal comprises a sealing lip 34 that is forming the second circumferential sealing portion 31b of the first seal member 31. The sealing lip 34 cooperates with a circumferential sealing surface of the circumferential frame 23 of the main filter element 2. In this example, the second seal member 32 is also a lip seal and comprises two lips 32a and 32b that cooperate with an inner wall of the housing 220.

The filter system shown in FIG. 7 and FIG. 8 comprises, besides the housing 220 and the filter assembly, a pre-cleaner 225. A pre-cleaner is known in the art and disclosed for example in US2018/0369735A1. The pre-cleaner removes most of the contamination and dirt from the incoming air before the air enters the main filter element. Generally, pre-cleaners are effective at removing the larger dirt particles and water droplets. As a result, they will greatly reduce the dirt reaching the air cleaner, resulting in extended life of the main filter element.

In embodiments, as illustrated in FIG. 8, after installation of the pre-cleaner, a press element 226 of the pre-cleaner 225 presses against the circumferential frame 23 of the main filter element 2. In this way, the first seal member 31 remains uniformly compressed over its entire circumferential length so as to provide for a leak-tight seal between the safety filter element and the main filter element. The press element of the pre-cleaner can, for example, be a circumferential rib or a plurality of smaller rib portions following the contour shape of the circumferential frame 23 of the main filter element. In these embodiments, an axial force exercised by the press element 226 is obtained by latching the pre-cleaner to the housing of the filter system when installing the pre-cleaner. An example of a connector is a latch. Typically, for latching the pre-cleaner to the housing, one or more connectors, e.g., latches, are used.

In embodiments, the pre-cleaner comprises one or more latches for latching the pre-cleaner to the housing of the filter system.

In other embodiments, the filter system comprises a cover instead of a pre-cleaner, and the cover is latched with one or more connectors to the housing of the filter system. After installation of the cover with the connectors, a press element of the cover presses against the circumferential frame 23 of the main filter element 2. In this way, the first seal member 31 remains compressed uniformly over its entire circumferential length. The press element of the cover is for example a circumferential rib or the press element is composed of a plurality of rib portions.

In embodiments, to ensure seal compression of the first seal member 31, after insertion of the main filter element into the safety filter element, the main filter element is locked to the safety filter element by locking means. The locking means are for example, a plurality of screws for screwing the main filter element to the safety filter element. Alternatively, the locking means may comprise a snap-fit connection between first and second snap fit components; a first component being arranged on the safety filter element, and a second component being arranged on the main filter element, both components being adapted for providing a snap-fit connection when the main element is received in or by the safety filter element. In these embodiments, even after removing the pre-cleaner or removing the cover, the main filter element remains sealingly locked in the safety filter element.

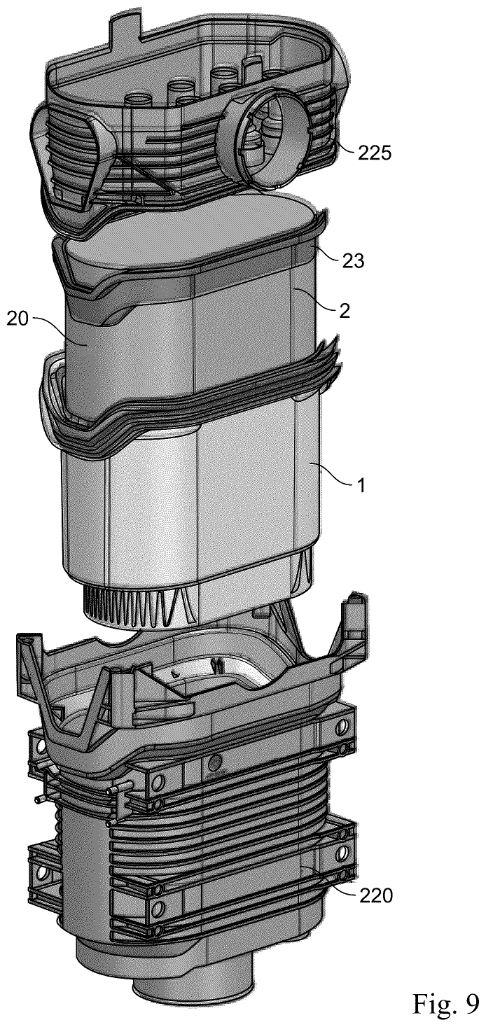

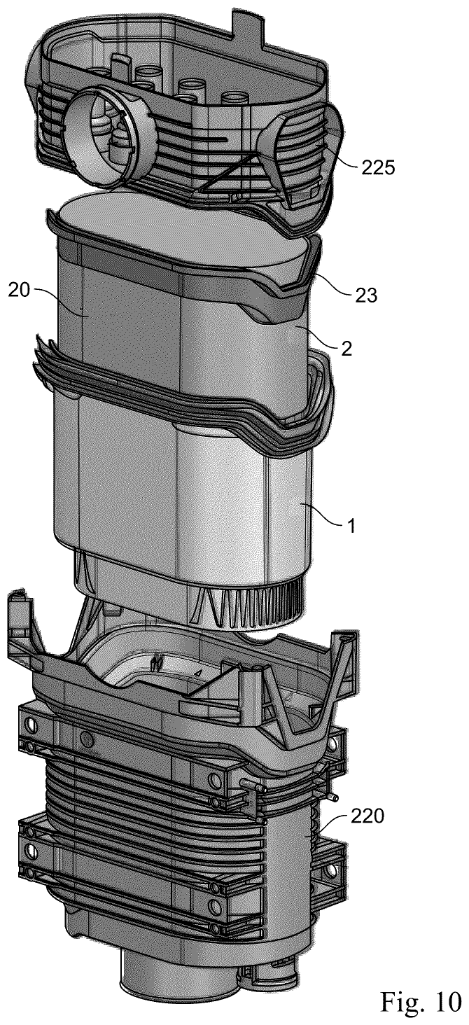

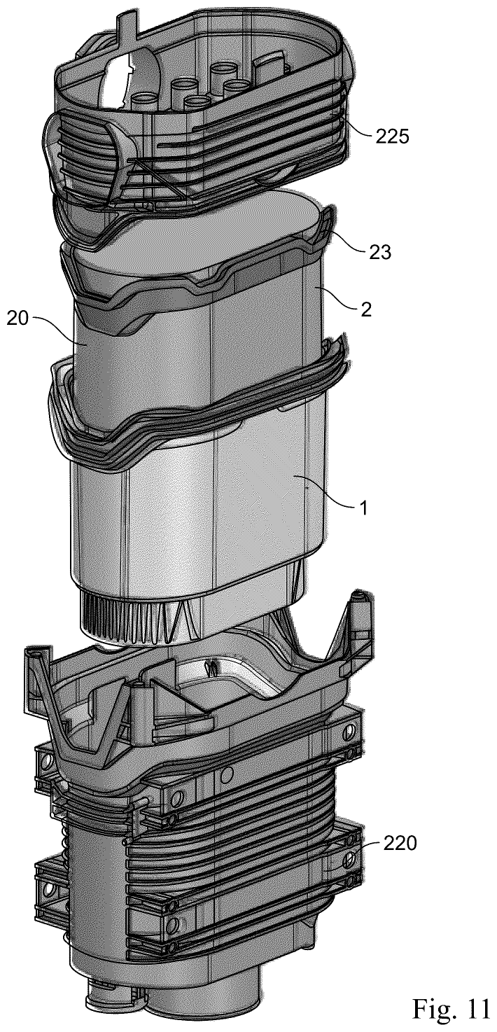

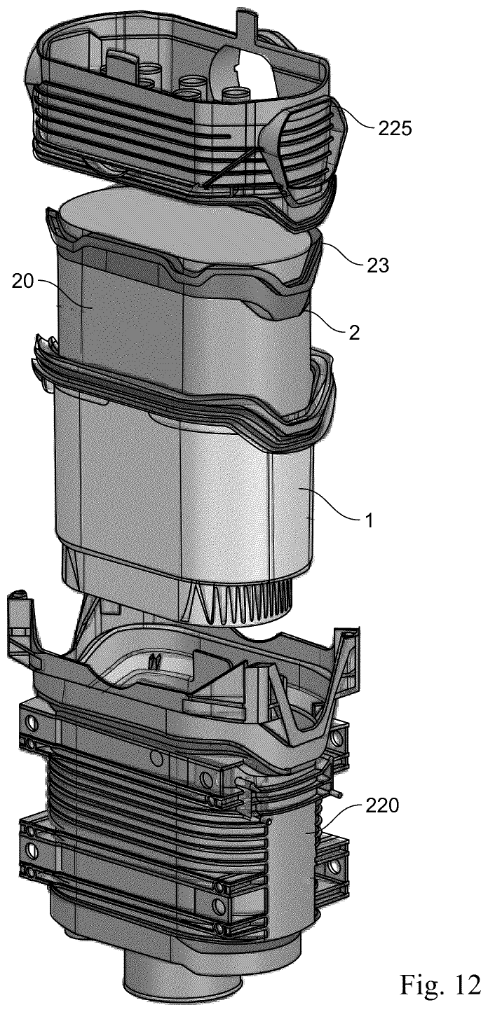

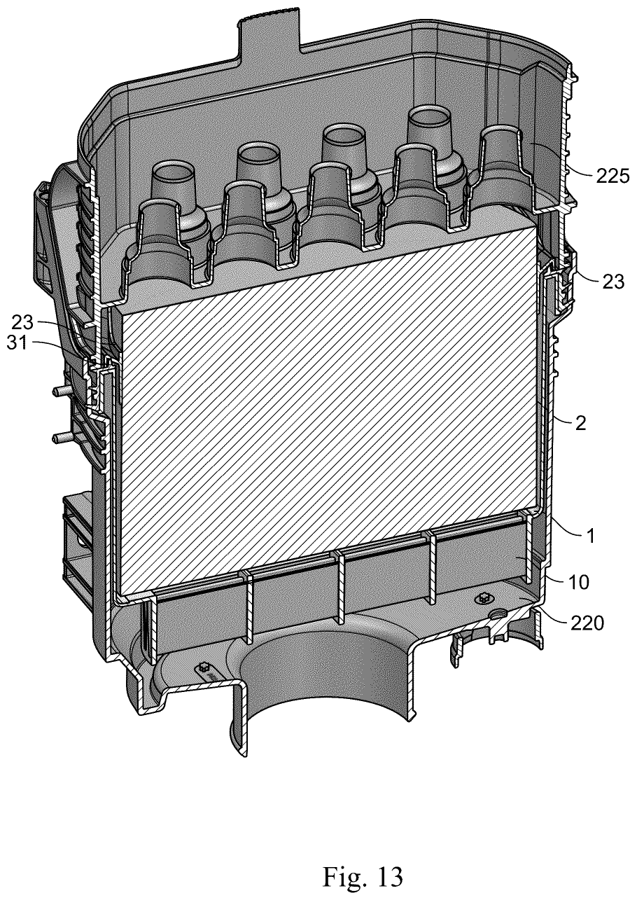

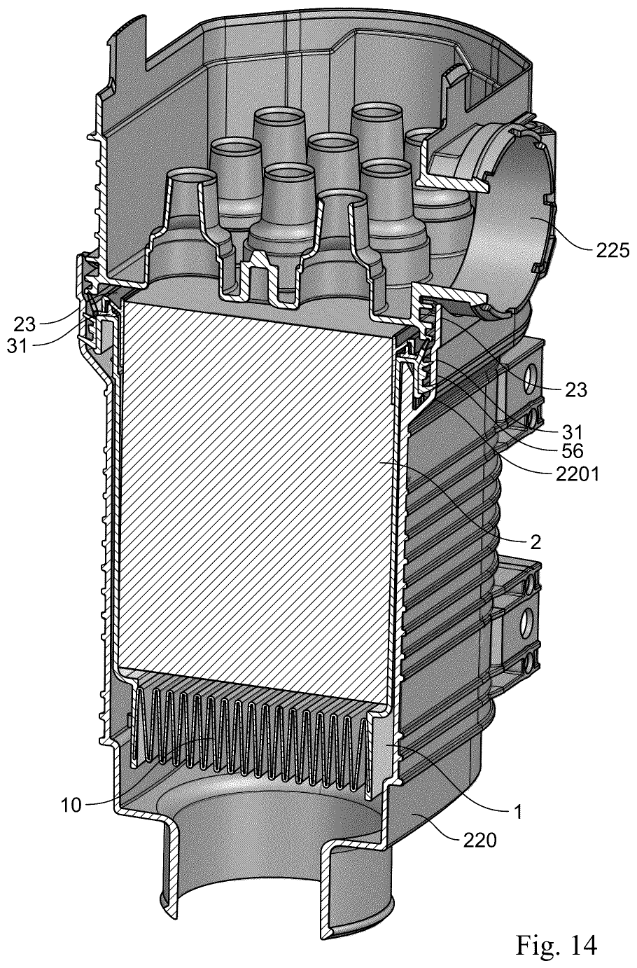

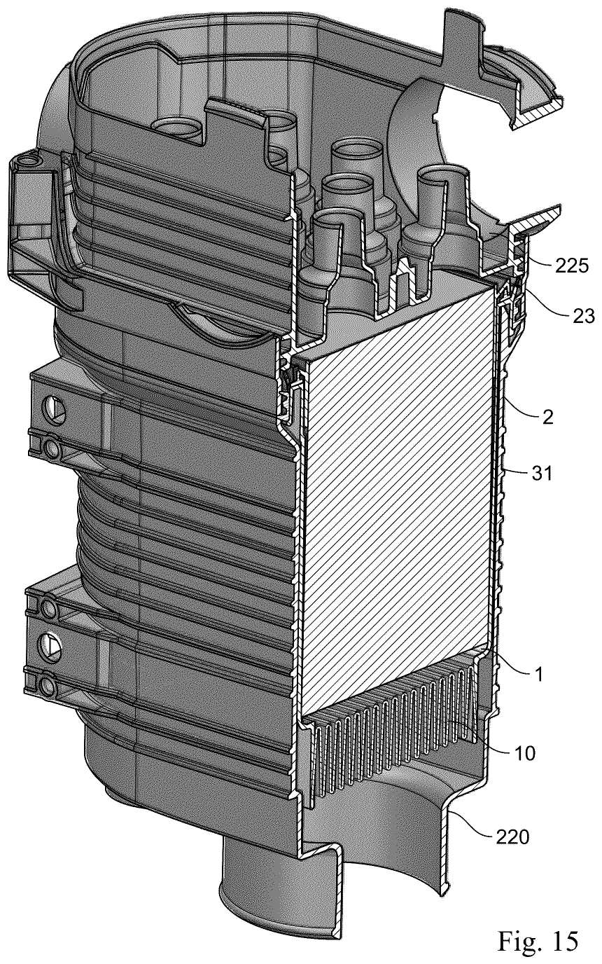

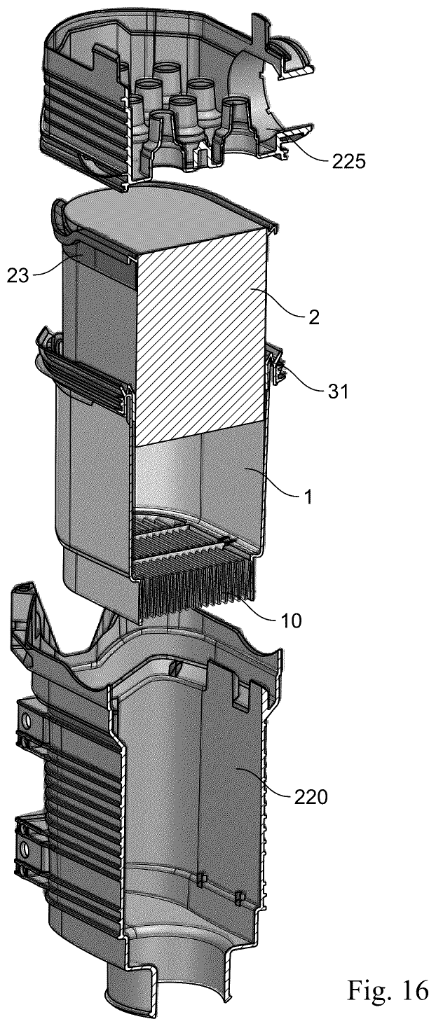

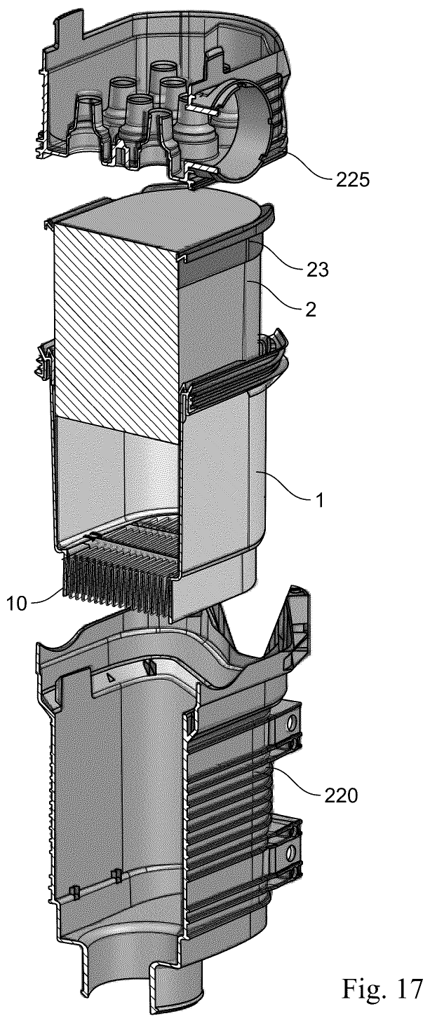

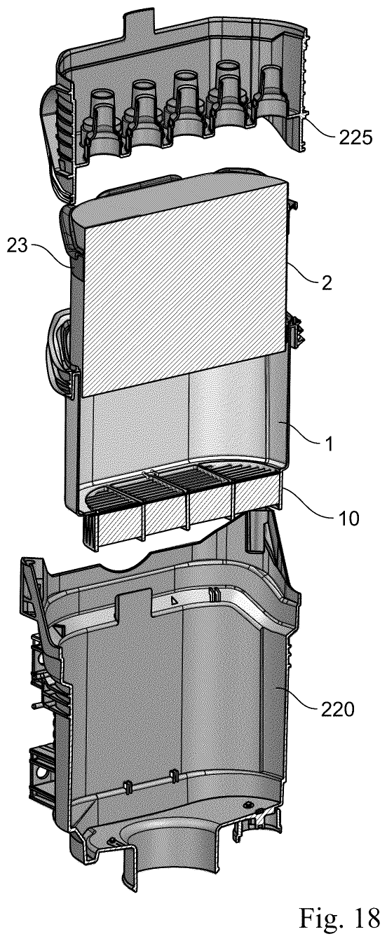

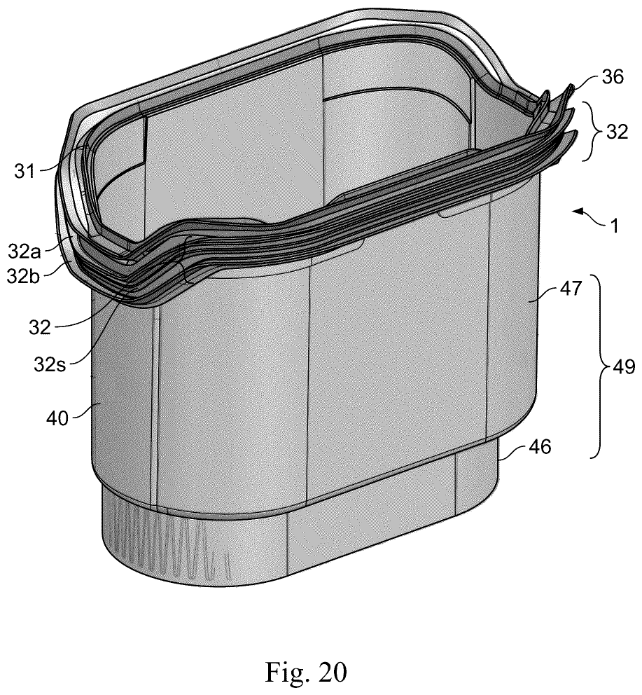

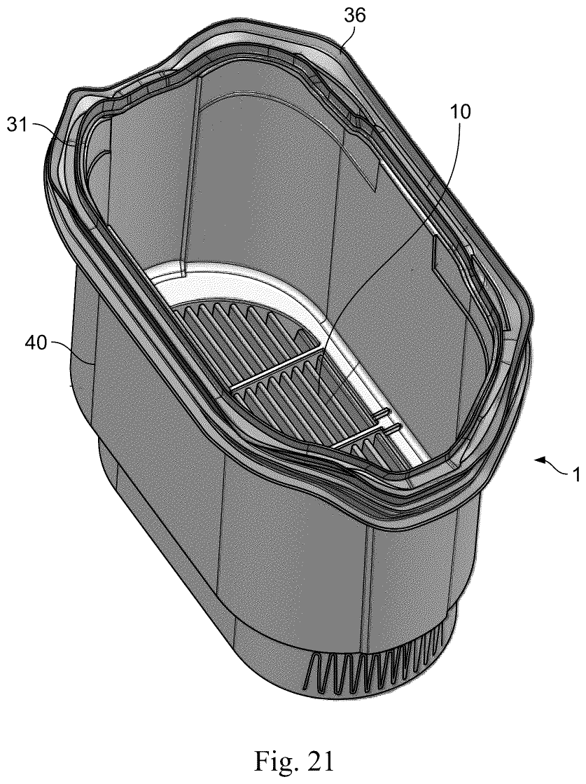

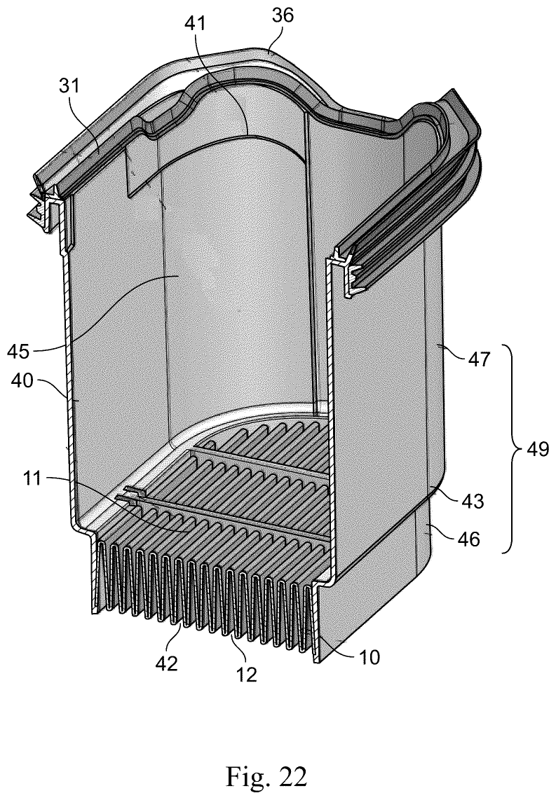

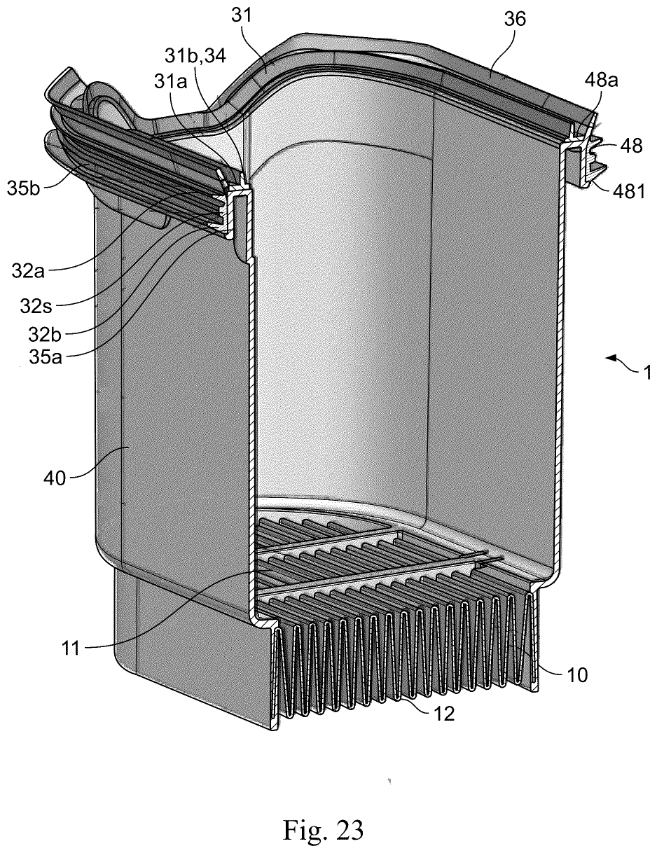

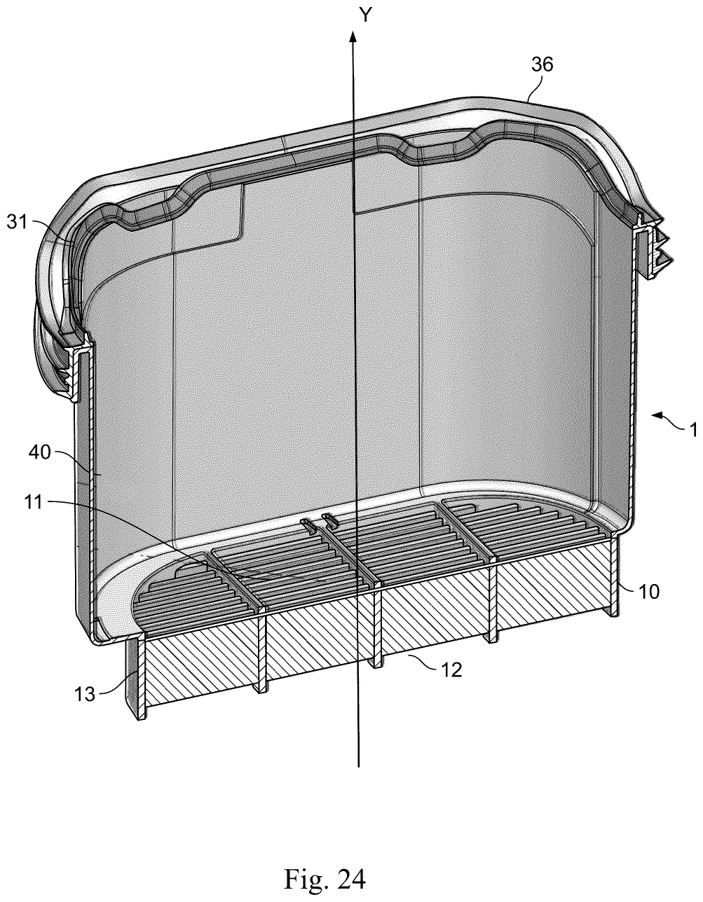

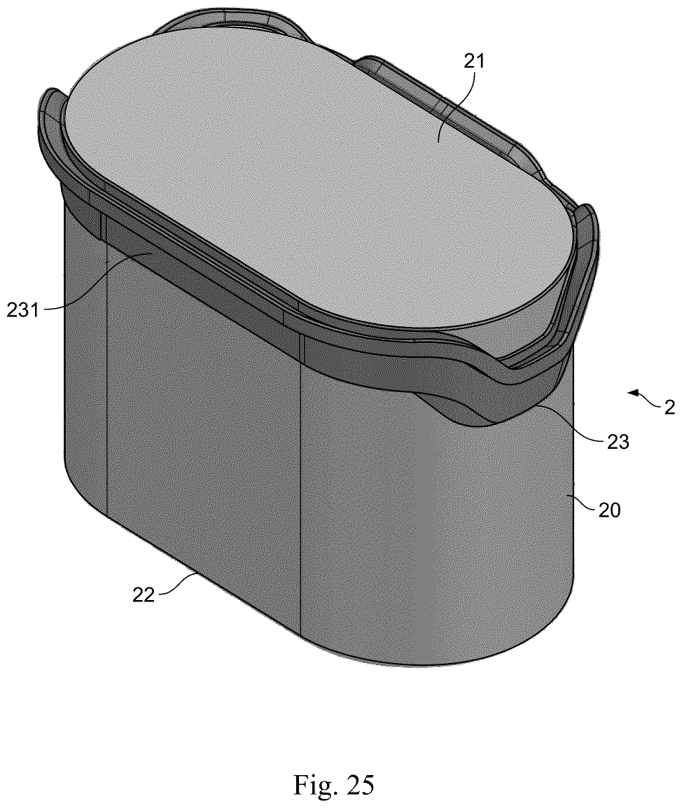

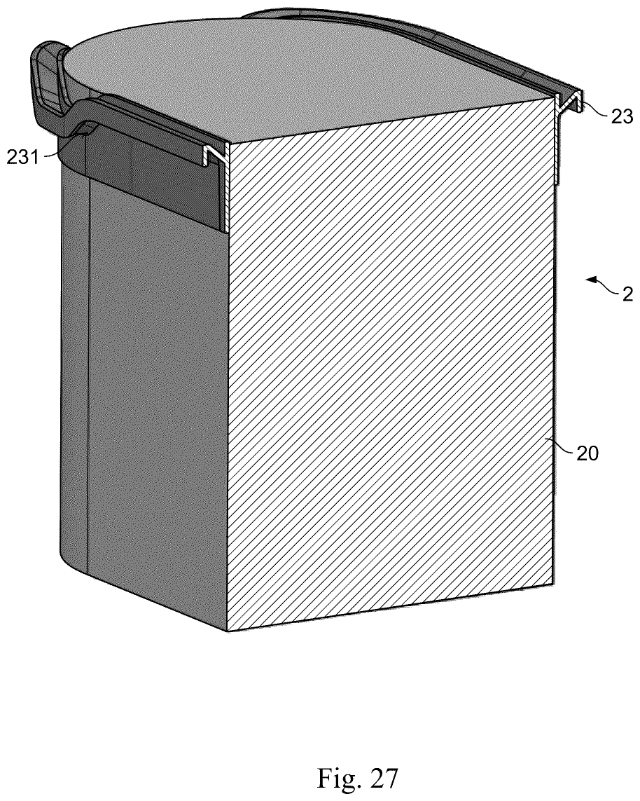

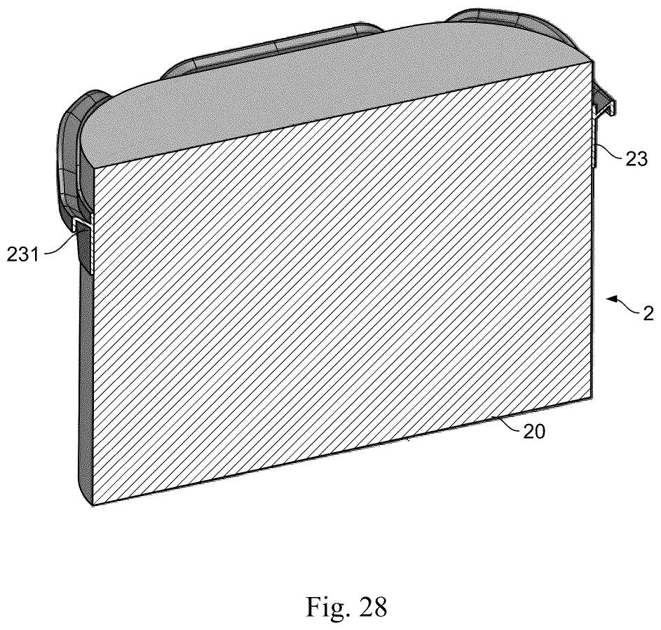

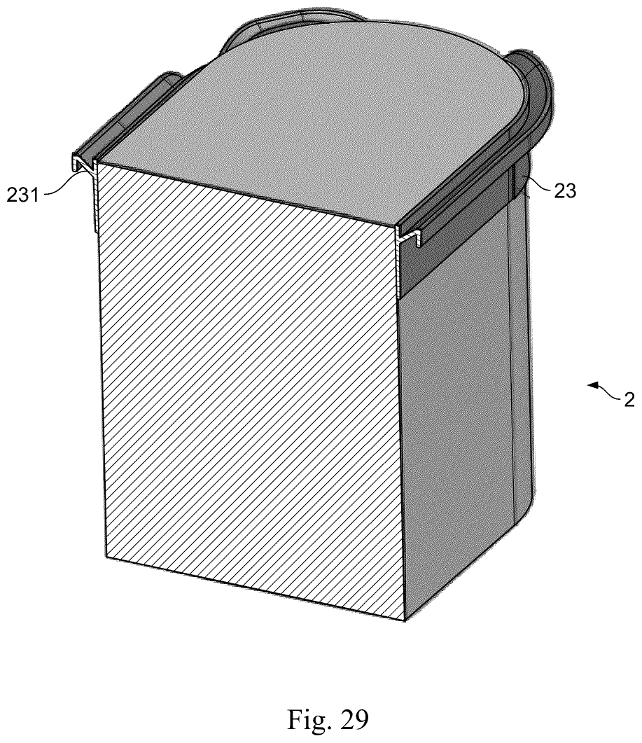

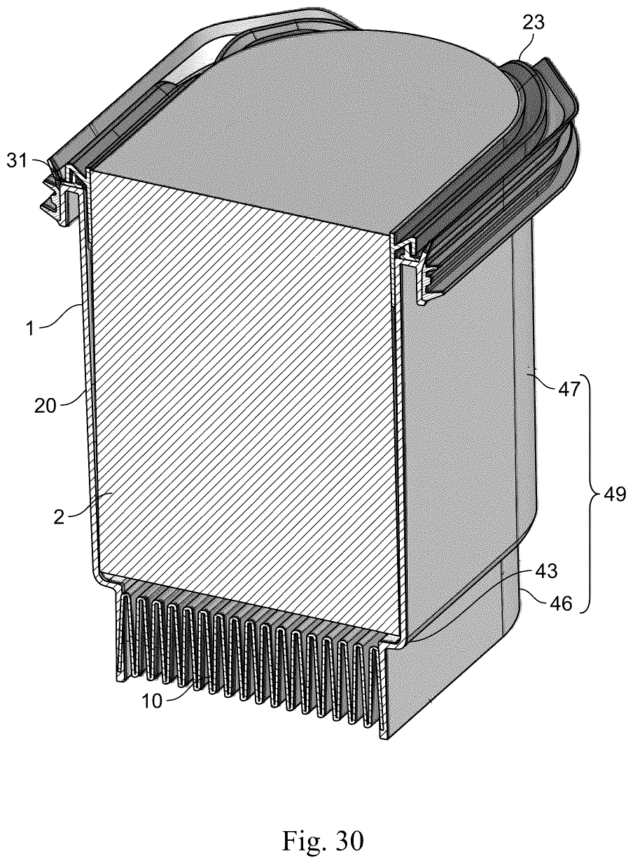

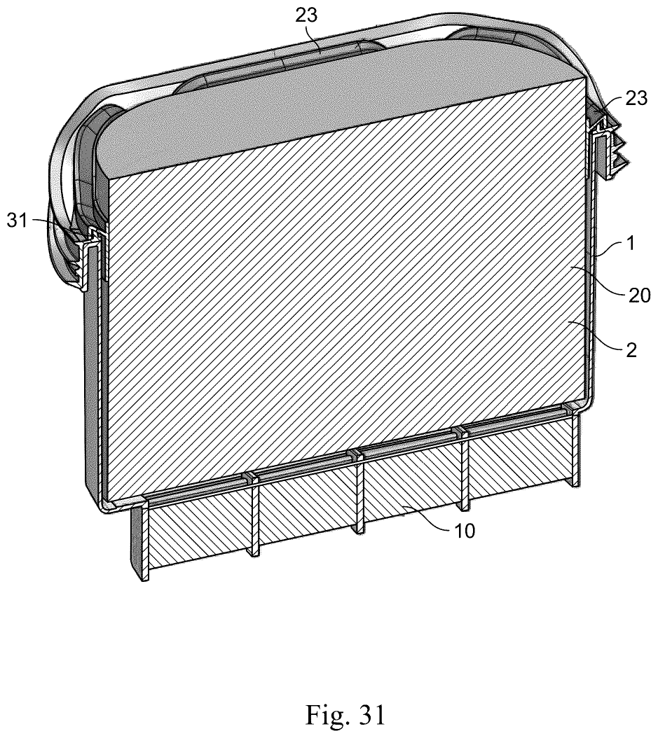

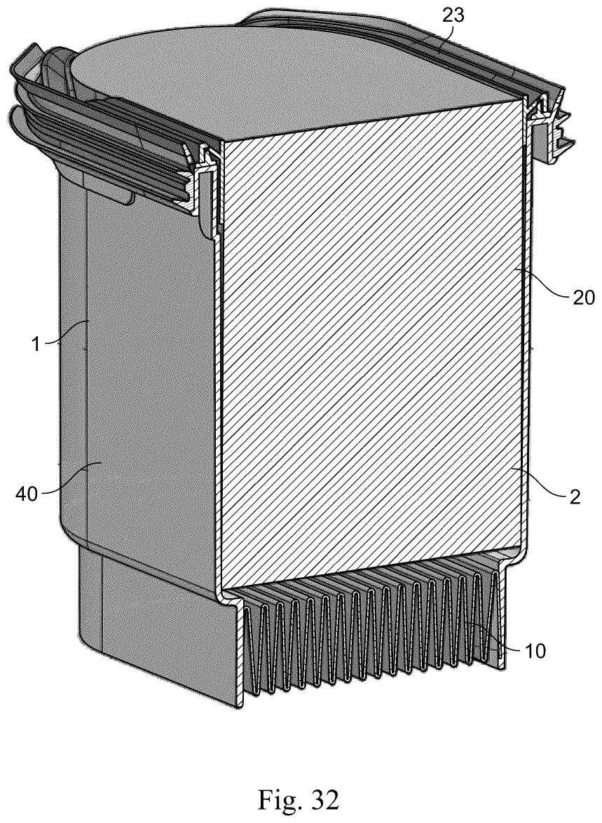

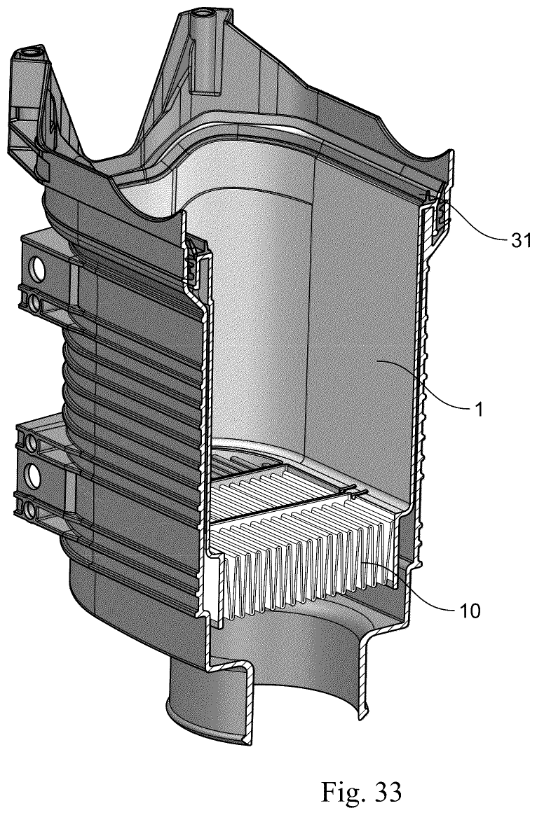

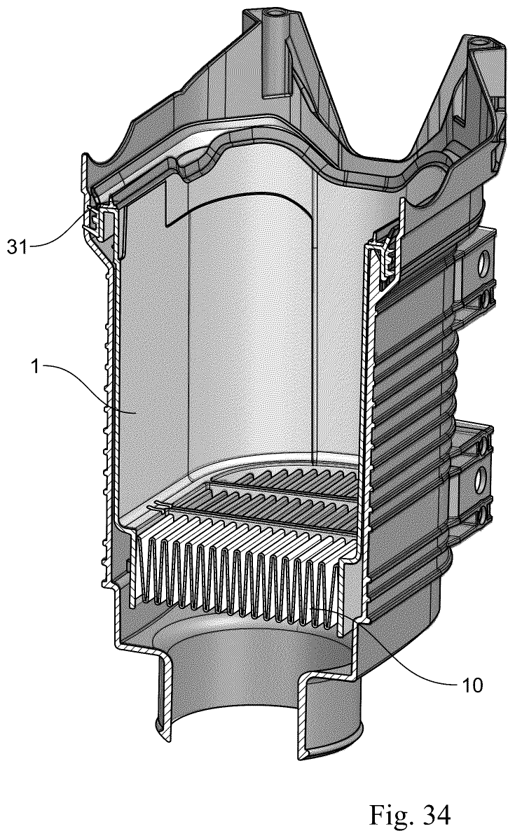

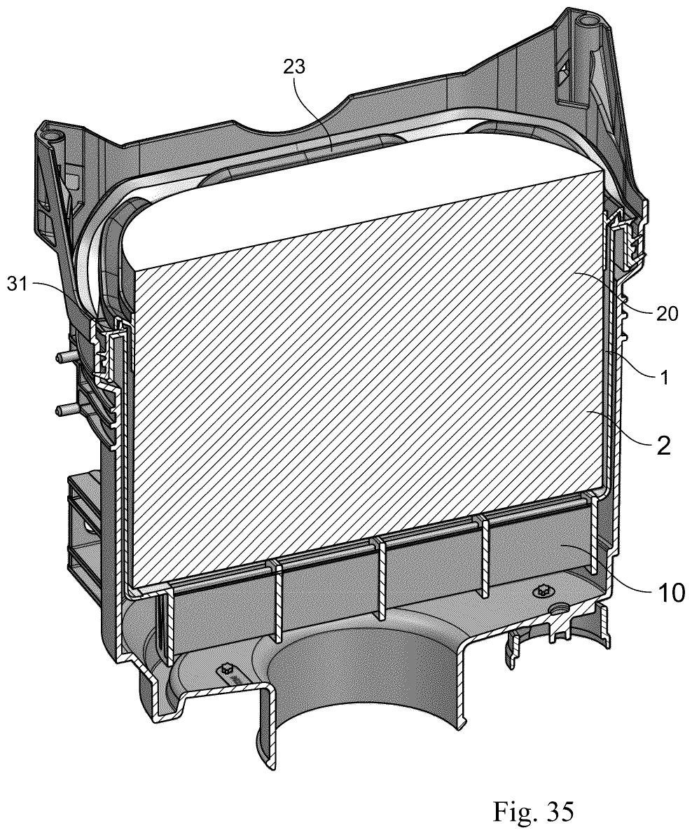

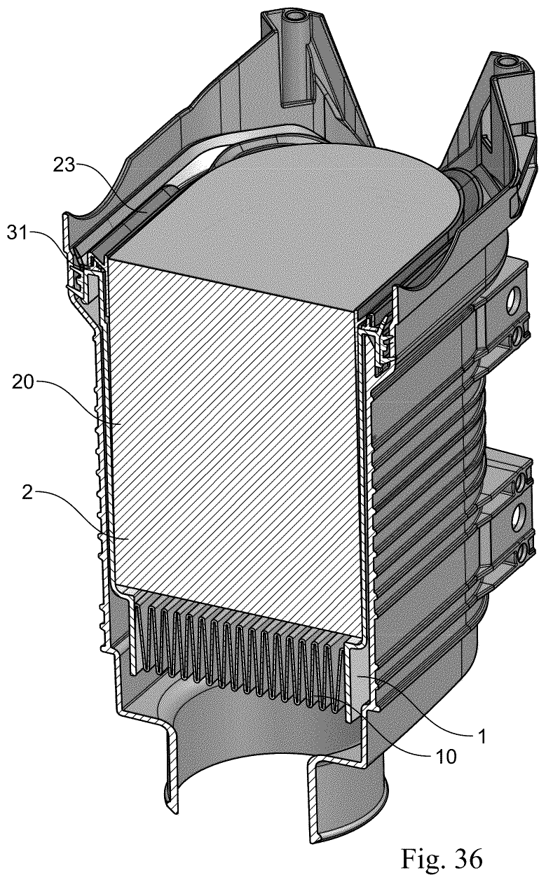

FIG. 9 to FIG. 37 illustrate a preferred embodiment of a fluid cleaner assembly, preferably an air cleaner assembly, a safety filter element, a main filter element, and a housing (including a housing part and a precleaner or cover part) of the present disclosure.

Preferred and optional features and feature combinations described for any of the previous embodiments are supposed to be also applicable to the embodiments described in relation with FIG. 9 to FIG. 37.

Also, preferred and optional features and feature combinations described in relating with the description below of FIG. 9 to FIG. 37 are also supposed to be applicable to the other embodiments of the present disclosure, mutatis mutandis if and where needed.

In the following description, the same reference numbers refer to the same or like features as described before. Not all reference signs have been provided in all drawings.

The disclosed preferred embodiment comprises a filter assembly 100 comprising a safety filter element 1, a main filter element 2 and a housing 220, the housing comprising a main portion and a cover or precleaner portion 225.

The safety filter element 1 is provided for backing up a failure of a main filter element comprising a primary filter medium pack. The safety filter element 1 comprises a secondary filter medium pack 10 having a circumferential side 13 extending in a longitudinal direction Y from a fluid inlet side 11 to a fluid outlet side 12, preferably a pleated filter medium pack. The safety filter element 1 further comprises a shell 40 comprising a circumferential wall 49 extending in the longitudinal direction Y from a first opening 41 at a first end of the shell to a second opening 42 at a second end of the shell. A first portion 46 of an inner side of the circumferential wall 49 is surrounding the circumferential side 13 of the secondary filter medium pack 10. A second portion 47 of the inner side of the circumferential wall 49 is radially delimiting a cavity 45 located between the first opening of the shell 41 and the fluid inlet side 11 of the secondary filter medium pack for receiving, or at least partly receiving, the primary filter medium pack of the main filter element. A first seal member 31 is provided comprising a first circumferential sealing portion 31a for sealing to the shell 40 and a second circumferential sealing portion 31b, 34 for sealing to the circumferential frame 23 of the main filter element 2, especially to a corresponding circumferential frame sealing surface 231. The second circumferential sealing portion 31b, 34 has a contour shape of single-fold rotational symmetry. Correspondingly, the circumferential frame sealing surface 231 has a contour shape of single-fold rotational symmetry.

Preferably, the shell 40 comprises or is made from plastic. Preferably, the seal member 31 comprises or consists of a thermoplastic elastomer.

The first seal member 31 is permanently coupled to the shell by sealingly attaching the first circumferential sealing portion 31a to the shell 40, for instance by overmolding onto the shell 40 via multi-component injection molding.

The first seal member 31 is a lip-type seal member comprising one sealing lip 34 and the sealing lip 34 is forming the second circumferential sealing portion 31b of the first seal member 31.

The shell 40 comprises a seal support flange 48 supporting the first seal member 31. The support flange 48 is located at the first end of the shell 40, and extends perpendicularly to the longitudinal direction Y of the shell.

The seal support flange 48 comprises a circumferential support surface 48a, and the first circumferential sealing portion 31a of the first seal member 31 is coupled to the circumferential support surface 48a.

The support flange further comprises a seal support flange extension 481 extending from an outer periphery of the flange 48 in a direction parallel to the longitudinal direction Y and towards the secondary filter medium pack 10. In a certain view, the first end of the shell 40 is folded backwards, thereby defining a U-shaped, circumferential, annular recess 56 (e.g., third positioning element). The support flange extension 481 is provided with a second seal member 32 on its radially directed outer surface.

The second circumferential sealing portion 31b, 34 of the first seal member 31 is configured for axially sealing or at least partly axially sealing with respect to the longitudinal direction Y.

The safety filter element comprises a second seal member 32 for sealing the safety filter element to a housing of a filter system. The second seal member 32 is permanently coupled to the shell 40. More specifically, the second seal member 32 is coupled to an outer side of the circumferential wall 49 of the shell 40, especially to the radially directed outer surface of the support flange extension 481.

The second seal member 32 comprises an inner circumferential side 35a for sealing to the shell 40 (extension 481) and an outer circumferential side 35b for sealing to the housing. The inner circumferential side 35a is coupled to an outer side of the circumferential wall 49 of the shell 40, specifically to the support flange extension 481.

The second seal member 32 is a lip-type seal member comprising two sealing lips 32a, 32b for sealing to the housing. Adjacent to one or more of the lips, for instance in between the two lips, a (one or more) seal member compression limiting element 32s is provided to stop the compression of the lip seals at a predetermined height. The outer circumferential side 35b of the second seal member 32 comprises two sealing lips 32a, 32b separated by a single seal member compression limiting element 32s. It preferably comprises a thermoplastic elastomer and is preferably formed by overmolding onto the shell 40 via multi-component injection molding.

As an optional feature, the safety filter element comprises a fourth seal member 36 for sealing the safety filter element to a cover or precleaner 225 housing of the filter assembly. The fourth seal member 36 is permanently coupled to the shell 40, for instance to flange surface 48a of the shell 40, or to the support flange extension 481. The fourth seal member 36 is a lip seal having one lip. The lip has a dominant axial sealing component for axial sealing with a corresponding surface of the cover or precleaner. It may also comprise a radial component. Alternatively, it can comprise a plurality of lips. The fourth seal member 36 is arranged in a circumferential manner, in between the first and second circumferential seal members 31, 32. For instance, the lip of the fourth seal member 36 can be arranged at the joint between the support flange 48 and the support flange extension 481. For instance, the lip of the fourth seal member 36 can point away from the filter medium pack 10. The (direction of the) lip of the fourth seal member 36 can form an angle with the (direction of the) lip of the first seal member 31 which is different from 0.

The circumferential side 13 of the secondary filter medium pack 10 is sealingly attached to the first portion 46 of the inner side of the circumferential wall 49 of the shell.

The contour shape of the second circumferential sealing portion 31b,34 of the first seal member 31 has a plane of mirror symmetry that crosses the fluid inlet side 11 and the fluid outlet side 12 of the secondary filter medium pack 10.

A cross-section between the second portion 47 of the inner side of the circumferential wall 49 of the shell 40 and a plane transverse to the longitudinal direction Y has an obround shape.

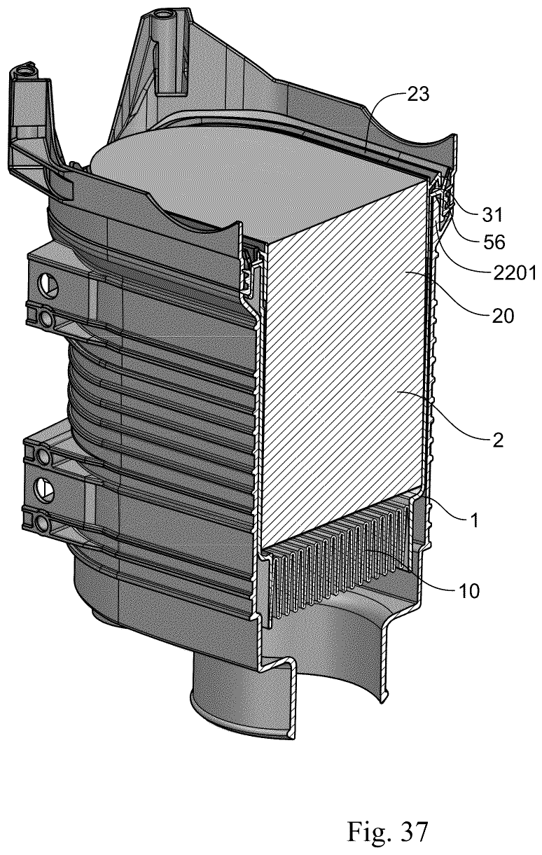

As shown in FIG. 37, the shell 40 comprises one or more third positioning elements 56 (defined for instance by the U-shaped recess) configured for facilitating positioning into the housing and for relative fixation of the safety filter element to the housing. For instance, the U-shaped recess 56 of the safety filter may receive axially extending protrusions or tabs 2201 (e.g., positioning elements) of the housing 220, when the safety filter element is received into the housing. The interaction of the one or more recesses 56 with fourth positioning elements 2201, for instance one or more axially extending protrusions 2201, may serve guiding purposes and radial alignment purposes, as well as radial fixation purposes.

The main filter element 2 comprises a primary filter medium pack 20, preferably a fluted media pack, receivable in the cavity 45 of the safety filter element 1. The main filter element 2 further comprises a circumferential frame 23 sealingly attached to the primary filter medium pack 20. The circumferential frame 23 comprises a circumferential sealing surface configured for sealingly cooperating with the second circumferential sealing portion 31b of the first seal member 31, when the primary filter medium pack 20 is received within the cavity 45. The circumferential frame 23 is sealingly attached to an outer circumferential face of the primary filter medium pack 20. The circumferential frame 23 of the main filter element 2 comprises a circumferential frame sealing surface 231. The circumferential frame sealing surface 231 preferably has a contour shape of single-fold rotational symmetry, corresponding to the single-fold rotational symmetry of the second circumferential sealing portion 31b, 34 of the safety filter element 1.

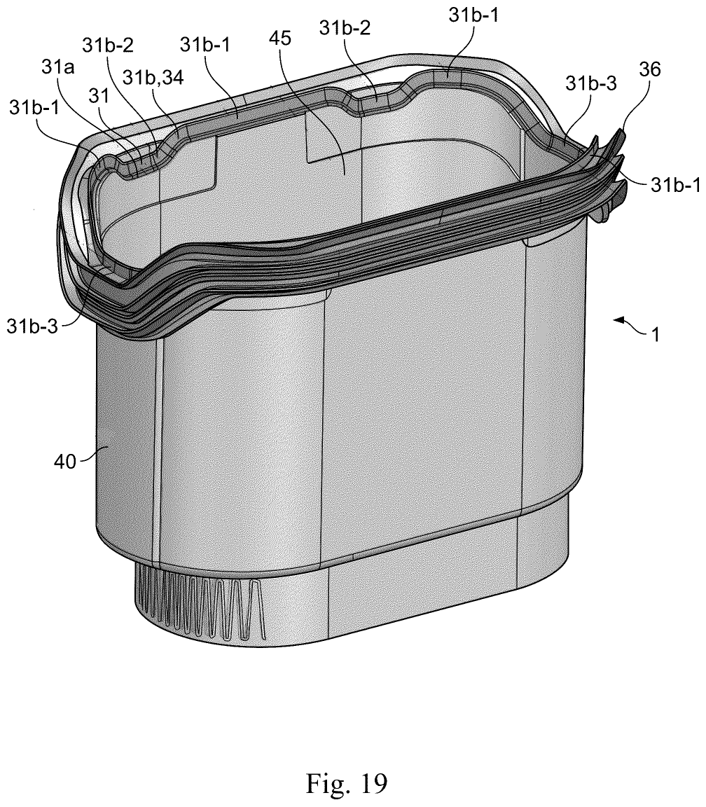

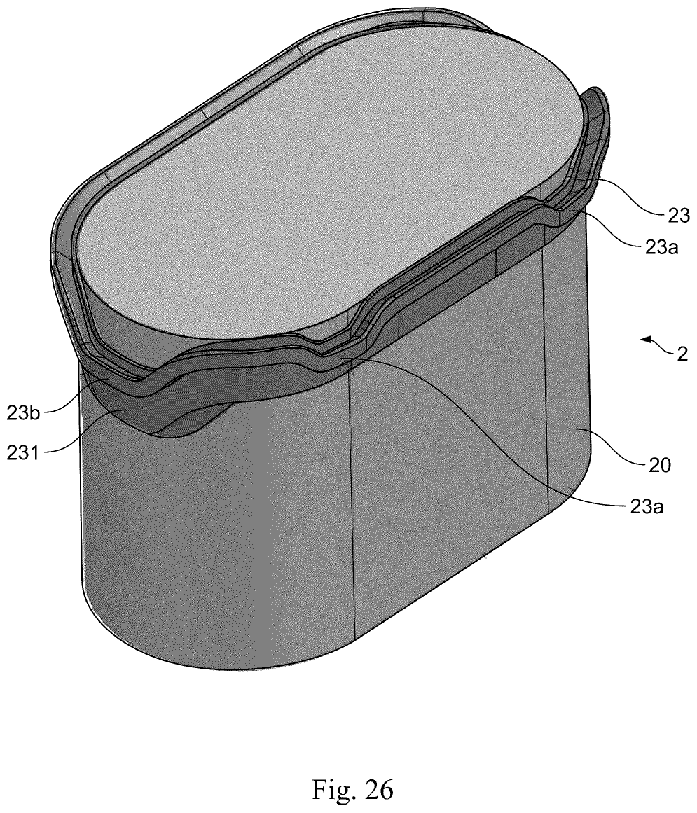

In one aspect, the single-fold rotational symmetry of the second circumferential sealing portion 31b, 34 can be achieved independently of the filter cartridge shape with axially deviating sealing portions. For example, and as most easily seen at FIG. 19, the second circumferential sealing portion 31b, 34 can include a main portion or portions 31b-1 from which one or more axially deviating portions 31b-2 are provided in an asymmetrical arrangement (e.g. provided on a first side of the shell 40 but not provided on the opposite side of the shell 40). As can be seen, for example at FIG. 26, the circumferential frame 23 and corresponding sealing surface are provided with corresponding axially deviating portions 23a that axially follow the contours defined by the axially deviating portions 31b-2 of the sealing portion 31b. In an aspect, the axially deviating portions 31b-2 enable the second circumferential sealing portion 31b, 34 to have single-fold rotational symmetry while still following the obround contour defined by the main filter element 2 and the corresponding shell cavity 45. In the example shown, two identically shaped axially deviating portions 31b-2 and 23 are shown and provided on a single side of the shell 40, in this case one of the long sides of the shell 40. However, other locations and numbers, such as one or more than two, are possible. In an aspect, the axially deviating portions 31b-2 and 23 may be characterized as having a trapezoidal shape. Other shapes are possible. In an aspect, the axially deviating portions 31b-2 and 23a are shown as extending in a direction from the main portion 31b-1 towards the fluid inlet side 11. Alternatively, the portions 31b-2 and 23a may be configured to extend in the opposite direction. The second circumferential sealing portion 31b, 34 may also be provided with axially deviating portions on the opposite long sidewall of the shell 40 from that shown in the drawings, whereby single-fold rotational symmetry can be achieved by having differently shaped and/or different numbers of asymmetrically located axially deviating portions 31b-2. With continued reference to FIGS. 19 and 26, the second circumferential sealing portion 31b, 34 is provided with additional axially deviating portions 31b-3 located at the longitudinal ends of the shell 40 that are received by corresponding axially deviating portions 23b on the filter cartridge frame 23. In the example shown, the axially deviating portions 31b-3, 23b are identically shaped at each end. However, the two portions 31b-3, 23b can be provided with different shapes from each other to give the second circumferential sealing portion 31b, 34 a shape with single-fold rotational symmetry without reliance on the axially deviating portions 31b-2.

The filter assembly further comprises a pre-cleaner 225 (only partially depicted) or a cover latchable to the rest of the housing 220 with one or more connectors.

When the precleaner or cover 225 is installed, the fourth seal member 36 of the safety filter element 1 seals against an inner surface of the precleaner or cover 225.

Although a number of the drawings presented and discussed above are specifically addressing embodiments of a filter element for filtering air, the present disclosure is not limited to filter elements for filtering any particular fluid.

In embodiments according to the present disclosure, the fluid is for example a gas such as air.

### REFERENCE NUMBERS

| | |
|---|---|
| 1 | Safety Filter element |
| 2 | Main filter element |
| 10 | Secondary filter medium pack |
| 11 | Fluid inlet side |
| 12 | Fluid outlet side |
| 13 | Circumferential side |
| 20 | Primary filter medium pack |
| 21 | Fluid inlet face |
| 22 | Fluid outlet face |
| 23 | Circumferential frame |
| 23a | Axially deviating portion |
| 23b | Axially deviating portion |
| 24 | Handle |
| 25 | Second positioning element |
| 26 | Rib element |
| 31 | First seal member |
| 31a | First circumferential sealing portion |
| 31b | Second circumferential sealing portion |
| 31b-1 | Main portion |
| 31b-2 | Axially deviating portion |
| 31b-3 | Axially deviating portion |
| 32 | Second seal member |
| 32a, 32b | Sealing lip of second seal member |
| 32s | Second seal member compression limiting element |
| 33 | Third seal member |
| 34 | Sealing lip of first seal member |
| 35a | Inner circumferential side of second seal member |
| 35b | Outer circumferential side of second seal member |
| 36 | Fourth seal member |
| 40 | Shell |
| 41 | First opening of the shell |
| 42 | Second opening of the shell |
| 43 | Third wall portion |
| 45 | Cavity |
| 46 | First portion of inner side of the circumferential wall |
| 47 | Second portion of inner side of the circumferential |
| | wall |
| 48 | Seal support flange |
| 48a | Circumferential support surface |
| 49 | Circumferential wall of the shell |
| 50 | Connecting arrangement |
| 50a, 50b | Pivoting connectors |
| 50c | Pivoting axis |
| 55 | First positioning element |
| 56 | Third positioning element |
| 100 | Filter assembly |
| 200 | Filter system |
| 220 | Housing |
| 225 | Pre-cleaner |
| 226 | Press element |
| 231 | Circumferential frame sealing surface |
| 481 | Seal support flange extension |
| 2201 | Fourth positioning element |

1. A safety filter element for backing up a failure of a main filter element comprising a primary filter medium pack, the safety filter element comprising:
a secondary filter medium pack having a circumferential side extending in a longitudinal direction from a fluid inlet side to a fluid outlet side;
wherein the safety filter element further comprises:
a shell comprising a circumferential wall extending in said longitudinal direction from a first opening at a first end of the shell to a second opening at a second end of the shell;
wherein a first portion of an inner side of the circumferential wall is surrounding the circumferential side of the secondary filter medium pack, and
wherein a second portion of the inner side of the circumferential wall is radially delimiting a cavity located between the first opening of the shell and the fluid inlet side of the secondary filter medium pack for receiving, or at least partly receiving, a primary filter medium pack of the main filter element; and
a first seal member comprising a first circumferential sealing portion for sealing to the shell and a second circumferential sealing portion for sealing to the main filter element, and wherein the second circumferential sealing portion has a contour shape of single-fold rotational symmetry.

2. The safety filter element according to claim 1, wherein the shell is made of or at least partly made of a thermoplastic material, preferably, the thermoplastic material is any of the following materials or mixtures and combinations thereof: acrylonitrile butadiene styrene, polypropylene, polyamide, polyethylene terephthalate, polylactic acid, polyethylene, polycarbonate, polystyrene, or polyvinyl chloride.

3. The safety filter element according to claim 1, wherein the first seal member is made of or at least partly made of any of the following list of materials or a mixture or combination thereof: rubber, thermoplastic elastomer, thermoset elastomer, or thermoplastic vulcanizate.

4. The safety filter element claim 1, wherein the first seal member is permanently coupled to the shell by sealingly attaching the first circumferential sealing portion to the shell, preferably the first seal member is overmolded onto the shell via multi-component injection molding or, alternatively, the first circumferential sealing portion of the first seal member is attached to the shell with an adhesive.

5. The safety filter element any of the previous claim 1, wherein said first seal member is a lip-type seal member comprising at least one sealing lip and wherein the at least one sealing lip is forming said second circumferential sealing portion of the first seal member.

6. The safety filter element according to claim 5, wherein said at least one sealing lip is disposed at an oblique angle with respect to said longitudinal direction, preferably said at least one sealing lip is outwardly inclined with respect to said longitudinal direction by at least 5 degrees.

7. The safety filter element according to claim 1, wherein the first seal member is made of or at least partly made of a polyurethane material.

8. The safety filter element according to claim 1, wherein the shell comprises a seal support flange supporting said first seal member, preferably said support flange is located at the first end of the shell.

9. The safety filter element according claim 1, wherein the shell comprises a seal support flange, and wherein said seal support flange comprises a circumferential support surface, and wherein said first circumferential sealing portion is coupled to said circumferential support surface, preferably said circumferential support surface is disposed at an oblique angle with respect to said longitudinal direction.

10. The safety filter element according to claim 1, wherein the first circumferential sealing portion of the first seal member is coupled to the circumferential wall of the shell, preferably coupled at the first end of the shell.

11. The safety filter element according to claim 1, wherein the first circumferential sealing portion of the first seal member is coupled to said second portion of the inner side of the circumferential wall of the shell.

12. The safety filter element according to claim 1, wherein the second circumferential sealing portion of the first seal member is configured for axially sealing or at least partly axially sealing with respect to said longitudinal direction.

13. The safety filter element according to claim 1, wherein the second circumferential sealing portion of the first seal member is configured for radially sealing or at least partly radially sealing with respect to said longitudinal direction.

14. The safety filter element according to claim 1, comprising a connecting arrangement for locking the safety filter element to a housing of a filter system, and wherein the connecting arrangement is coupled to the shell.

15. The safety filter element according to claim 14, wherein the connecting arrangement comprises any or a combination of: one or more latches, one or more snap-fit connectors, one or more pivoting connectors, one or more hinges, one or more screws, one or more slots, one or more notches, one or more indentations, one or more latch receivers, or one or more snap-fit receivers.

16. (canceled)

17. The safety filter element according to claim 1, comprising a second seal member for sealing the safety filter element to a housing of a filter system, and wherein the second seal member is permanently, or alternatively removably, coupled to the shell, preferably the second seal member is coupled to an outer side of the circumferential wall of the shell.

18. (canceled)

19. (canceled)

20. (canceled)

21. (canceled)

22. (canceled)

23. (canceled)

24. (canceled)

25. (canceled)

26. (canceled)

27. The safety filter element according claim 1, wherein the circumferential side of the secondary filter medium pack is sealingly attached to said first portion of the inner side of the circumferential wall of the shell.

28. The safety filter element according to claim 1, wherein the secondary filter medium pack is removably coupled to the shell-, preferably the safety filter element comprises a third seal member configured for sealing a gap between the circumferential side of the secondary filter medium pack and the first portion of the inner side of the circumferential wall of the shell.

29. The safety filter element according to claim 1, wherein the contour shape of the second circumferential sealing portion of the first seal member has a plane of mirror symmetry that crosses the fluid inlet side and the fluid outlet side of the secondary filter medium pack.

30. The safety filter element according to claim 1, wherein a contour shape of said second portion of the inner side of the circumferential wall of the shell has a single-fold rotational symmetry.

31. The safety filter element according to claim 1, wherein a cross-section between the second portion of the inner side of the circumferential wall of the shell and a plane transverse to the longitudinal direction has a shape selected of any of the following shapes: round, obround, race-track shape, peanut shape, banana shape, elliptical shape, square, or rectangular.

32. The safety filter element according to claim 1, wherein the circumferential wall of the shell is rotationally symmetric with respect to an axis of rotation parallel with the longitudinal direction.

33. The safety filter element according to claim 1, wherein the shell has a discrete N-fold rotational symmetry with respect to an axis of rotation parallel with the longitudinal direction, with N>1.

34. (canceled)

35. The safety filter element according to claim 1, wherein the shell comprises one or more first positioning elements configured for facilitating positioning of the main filter element into the cavity of the safety filter element.

36. (canceled)
